(19) United States
(12) Patent Application Publication
(10) Pub. No.: US 2015/0174929 A1
(43) Pub. Date: Jun. 25, 2015

(54) INK JET PRINTING APPARATUS AND IMAGE PROCESSING APPARATUS

(71) Applicant: CANON KABUSHIKI KAISHA, Tokyo (JP)

(72) Inventors: Hiromitsu Yamaguchi, Yokohama-shi (JP); Yoshitomo Marumoto, Kawasaki-shi (JP); Hitoshi Tsuboi, Kawasaki-shi (JP); Ryota Kato, Yokohama-shi (JP); Takayuki Ushiyama, Kawasaki-shi (JP)

(21) Appl. No.: 14/564,442

(22) Filed: Dec. 9, 2014

(30) Foreign Application Priority Data
Dec. 24, 2013 (JP) 2013-265378

(51) Int. Cl. B41J 13/00

(52) U.S. Cl. CPC B41J 13/0009

(57) ABSTRACT

An ink jet printing apparatus and an image processing apparatus capable of stably outputting an image with no joint streak by making the density uniform in the entire range in which the joint streak appears are provided. Consequently, the number of dots that are printed is adjusted for image data corresponding to the boundary part between printing scans performed twice and the vicinity thereof. At this time, a ration in which the number of dots that are printed in increased or decreased from a default value based the image data is changed stepwise toward a direction in which the distance from the boundary part increases. Due to this, adjustment of an appropriate number of dots in accordance with each position within the range in which the joint streak appears is performed, and therefore, it is possible to make the joint streak no longer conspicuous.

### BACKGROUND OF THE INVENTION

1. Field of the Invention

The present invention relates to an ink jet printing apparatus and an image processing apparatus.

2. Description of the Related Art

In a serial type ink jet printing apparatus, a printing scan in which a printing head is moved while causing the printing head to eject ink in accordance with image data and a conveyance operation to convey a printing medium in a direction intersecting the direction of the printing scan are repeated alternately. At this time, there is a case where a joint streak occurs at the boundary part between the regions in which printing is performed by printing scans performed twice successively in the printing medium.

For example, Japanese Patent Laid-Open No. H08-25693 (1996) has disclosed the method in which two printing regions of printing scans performed successively are overlapped each other to a certain extent in the conveyance direction and adjusting the number of dots that are printed in the overlapped region by using a mask pattern. At this time, by using a gradation mask pattern wherein the printing ratio at end parts of the printing head is reduced gradually, it is possible to suppress density unevenness in each overlapped region.

Further, Japanese Patent Laid-Open No. 2002-36524 has disclosed the method for counting the number of dots that are printed in the vicinity of the boundary part and adjusting the thinning ratio at the boundary part in accordance with the number of counted dots without providing an overlapped region. Conspicuousness of a joint streak depends on the gradations, i.e., the number of dots that are printed, but by adopting Japanese Patent Laid-Open No. 2002-36524, it is possible to appropriately adjust the number of dots at the boundary part in accordance with the gradations, and therefore, it is made possible to make less conspicuous the joint streak regardless of the density. On the other hand, Japanese Patent Laid-Open No. 2008-922 has disclosed a method for adding dots at the joint part region by focusing on, in particular, a white streak.

However, in the case where Japanese Patent Laid-Open No. H08-25693 (1966) is adopted, the number of times of printing scan required to print an image is different between the overlapped region and the other region. Specifically, in the case of the one-pass printing, in the overlapped region, ink is given by two printing scans, but in the other region, ink is given by one printing scan. As a result, for example, in the case where printing is performed on glossy paper by using, for example, a pigment ink, there is produced a difference in the degree of irregularities of the image surface, i.e., smoothness between the overlapped region and the other region, and the difference may be erroneously recognized as glossiness unevenness. Further, in the case where mixed-color printing is performed by using inks in two or more colors, there is produced a difference in the color tone and saturation between the overlapped region and the other region and the difference may be erroneously recognized as color unevenness.

According to the intensive examination by the inventors of the present invention, even in the case where Japanese Patent Laid-Open No. 2002-36524 was adopted and the thinning ratio at the boundary region was adjusted in accordance with the gradation without providing the overlapped region, it was recognized that the joint streak was not reduced sufficiently or the joint streak was made more conspicuous on the contrary. Specific explanation will be given below.

Even in the case where a printing scan is performed without providing an overlap region, the joint streak appears with a certain thickness and the range thereof (the thickness of the joint streak) varies depending on a variety of conditions, such as the kind of ink and the kind of printing medium. Then, in the range in which the joint streak appears, the intensity of the joint streak, i.e., the density is not uniform. In the case where dots are added or reduced in a uniform ratio with the range in which the joint streak appears in such circumstances, there may be a portion where the addition or reduction of dots is too much or insufficient, and the joint streak is left in such a portion as a result.

### SUMMARY OF THE INVENTION

The present invention has been made in order to solve the above-described problems. Consequently, an object thereof is to provide an ink jet printing apparatus and an image processing apparatus capable of stably outputting an image with no joint streak by making the density uniform in the entire range in which the joint streak appears.

In a first aspect of the present invention, there is provided an ink jet printing apparatus that prints an image on a printing medium by repeating a printing scan wherein an eject port column, in which eject ports for ejecting ink to print dots on the printing medium in accordance with image data are arrayed, is moved with respect to the printing medium and a conveyance operation to convey the printing medium in a direction intersecting the direction of the printing scan, the ink jet printing apparatus comprising: a conveyance control unit configured to control the printing scan and the conveyance operation so that a position where dots are printed by the eject port located at one end part of the eject port column and a position where dots are printed by the eject port located at the other end part are adjacent to each other via a boundary part by the printing scan performed twice on the printing medium; and a correction unit configured to perform correction processing on image data corresponding to the vicinity of the boundary part in order to adjust the number of dots that are printed, wherein the correction unit performs the correction processing so that a ratio in which the number of dots that are printed is increased or decreased from a default value based on the image data is changed at least in two steps toward a direction in which the distance from the boundary part increases.

In a second aspect of the present invention, there is provided an image processing apparatus that performs processing on multivalued image data corresponding to a unit region for printing an image in the unit region including a plurality of pixel regions on a printing medium by a plurality of scans of a an eject port column in which a plurality of eject ports for ejecting ink are arrayed in a predetermined direction with respect to the printing medium, wherein the plurality of eject ports ejects ink to each of the plurality of pixel regions on the printing medium in accordance with dot printing data corresponding to each of the plurality of scans, and by conveying the printing medium between the plurality of scans, the image processing apparatus comprising: a first acquisition unit configured to acquire information on a density of an image that is printed in the pixel region; a second acquisition unit configured to acquire N (≧3)-valued quantized data corresponding to the pixel region based on the image data; a third acquisition unit configured to acquire a plurality of dot arrangement pattern groups including at least a first dot arrangement pattern group including a plurality of first dot arrangement patterns in which an arrangement of dots is determined so that the number and position of dots that are printed within the pixel region are different in accordance with a value of the N-valued quantized data and a second dot arrangement pattern group including a plurality of second dot arrangement patterns in which an arrangement of dots is determined so that the number and position of dots that are printed within the pixel region are different in accordance with a value of the N-valued quantized data; a setting unit configured to set one dot arrangement pattern group from the plurality of dot arrangement pattern groups acquired by the third acquisition unit in accordance with the positions of the plurality of pixel regions within the unit region; and a generation unit configured to generate the dot printing data based on the N-valued quantized data acquired by the second acquisition unit and the dot arrangement pattern group set by the setting unit, wherein the number of dots that are printed within the pixel region determined by the second dot arrangement pattern corresponding to the N-valued quantized data having a predetermined value is smaller than the number of dots that are printed within the pixel region determined by the first dot arrangement pattern corresponding to the N-valued quantized data having the predetermined value, and the setting unit sets the dot arrangement pattern group so that: (i) the number of the second dot arrangement pattern groups determined for the plurality of pixel regions located at a first position, that is included in an end part region of the unit region in the predetermined direction corresponding to an end part of the eject port column in the predetermined direction, in a case where the density of the image indicated by the information acquired by the first acquisition unit is a first value is smaller than the number of the second dot arrangement pattern groups determined for the plurality of pixel regions located at the first position in a case where the density of the image indicated by the information acquired by the first acquisition unit is a second value lower than the first value; (ii) the number of the second dot arrangement pattern groups determined for the plurality of pixel regions located at a second position, that is included in the end part region and is closer to an end of the unit region than the first position in the predetermined direction, in a case where the density of the image indicated by the information acquired by the first acquisition unit is the first value is smaller than the number of the second dot arrangement pattern groups determined for the plurality of pixel regions located at the second position in a case where the density of the image indicated by the information acquired by the first acquisition unit is the second value; and (iii) the number of the second dot arrangement pattern groups determined for the plurality of pixel regions located at the second position in a case where the density of the image indicated by the information acquired by the first acquisition unit is the second value is larger than the number of the second dot arrangement pattern groups determined for the plurality of pixel regions located at the first position in a case where the density of the image indicated by the information acquired by the first acquisition unit is the second value, and the number of the first dot arrangement pattern groups determined for the plurality of pixel regions located at the second position in a case where the density of the image indicated by the information acquired by the first acquisition unit is the second value is smaller than the number of the first dot arrangement pattern groups determined for the plurality of pixel regions located at the first position in a case where the density of the image indicated by the information acquired by the first acquisition unit is the second value.

In a third aspect of the present invention, there is provided an image processing apparatus that performs processing on multivalued image data corresponding to a unit region for printing an image in the unit region including a plurality of pixel regions on a printing medium by a plurality of scans of a an eject port column in which a plurality of eject ports for ejecting ink are arrayed in a predetermined direction with respect to the printing medium, wherein the plurality of eject ports ejects ink to each of the plurality of pixel regions on the printing medium in accordance with dot printing data corresponding to each of the plurality of scans, and by conveying the printing medium between the plurality of scans, the image processing apparatus comprising: a first acquisition unit configured to acquire information on a density of an image that is be printed in the pixel region; a second acquisition unit configured to acquire N (≧3)-valued quantized data corresponding to the pixel region based on the image data; a third acquisition unit configured to acquire a plurality of dot arrangement pattern groups including at least a first dot arrangement pattern group including a plurality of first dot arrangement patterns in which an arrangement of dots is determined so that the number and position of dots that are printed within the pixel region are different in accordance with a value of the N-valued quantized data and a second dot arrangement pattern group including a plurality of second dot arrangement patterns in which an arrangement of dots is determined so that the number and position of dots that are printed within the pixel region are different in accordance with a value of the N-valued quantized data; a setting unit configured to set one dot arrangement pattern group from the plurality of dot arrangement pattern groups acquired by the third acquisition unit in accordance with the positions of the plurality of pixel regions within the unit region; and a generation unit configured to generate the dot printing data based on the N-valued quantized data acquired by the second acquisition unit and the dot arrangement pattern group set by the setting unit, wherein the number of dots that are printed within the pixel region determined by the second dot arrangement pattern corresponding to the N-valued quantized data having a predetermined value of the first and second dot arrangement pattern groups is larger than the number of dots that are printed within the pixel region determined by the first dot arrangement pattern corresponding to the N-valued quantized data having the predetermined value, and the setting unit sets the dot arrangement pattern group so that: (i) the number of the second dot arrangement pattern groups determined for the plurality of pixel regions located at a first position, that is included in an end part region of the unit region in the predetermined direction corresponding to an end part of the eject port column in the predetermined direction, in a case where the density of the image indicated by the information acquired by the first acquisition unit is a first value is smaller than the number of the second dot arrangement pattern groups determined for the plurality of pixel regions located at the first position in a case where the density of the image indicated by the information acquired by the first acquisition unit is a second value higher than the first value; (ii) the number of the second dot arrangement pattern groups determined for the plurality of pixel regions located at a second position, that is included in the end part region and is closer to an end of the unit region than the first position in the predetermined direction, in a case where the density of the image indicated by the information acquired by the first acquisition unit is the first value is smaller than the number of the second dot arrangement pattern groups determined for the plurality of pixel regions located at the second position in a case where the density of the image indicated by the information acquired by the first acquisition unit is the second value; and (iii) the number of the second dot arrangement pattern groups determined for the plurality of pixel regions located at the second position in a case where the density of the image indicated by the information acquired by the first acquisition unit is the second value is larger than the number of the second dot arrangement pattern groups determined for the plurality of pixel regions located at the first position in a case where the density of the image indicated by the information acquired by the first acquisition unit is the second value, and the number of the first dot arrangement pattern groups determined for the plurality of pixel regions located at the second position in a case where the density of the image indicated by the information acquired by the first acquisition unit is the second value is smaller than the number of the first dot arrangement pattern groups determined for the plurality of pixel regions located at the first position in a case where the density of the image indicated by the information acquired by the first acquisition unit is the second value.

In a fourth aspect of the present invention, there is provided an image processing apparatus that performs processing on multivalued image data corresponding to a unit region for printing an image in the unit region including a plurality of pixel regions on a printing medium by a plurality of scans of a an eject port column in which a plurality of eject ports for ejecting ink are arrayed in a predetermined direction with respect to the printing medium, wherein the plurality of eject ports ejects ink to each of the plurality of pixel regions on the printing medium in accordance with dot printing data corresponding to each of the plurality of scans, and by conveying the printing medium between the plurality of scans, the image processing apparatus comprising: a first acquisition unit configured to acquire information on a density of an image that is be printed in the pixel region; a second acquisition unit configured to acquire N (≧3)-valued quantized data corresponding to the pixel region based on the image data; a third acquisition unit configured to acquire a plurality of dot arrangement pattern groups including at least a first dot arrangement pattern group including a plurality of first dot arrangement patterns in which an arrangement of dots is determined so that the number and position of dots that are printed within the pixel region are different in accordance with a value of the N-valued quantized data and a second dot arrangement pattern group including a plurality of second dot arrangement patterns in which an arrangement of dots is determined so that the number and position of dots that are printed within the pixel region are different in accordance with a value of the N-valued quantized data; a setting unit configured to set one dot arrangement pattern group from the plurality of dot arrangement pattern groups acquired by the third acquisition unit in accordance with the positions of the plurality of pixel regions within the unit region; and a generation unit configured to generate the dot printing data based on the N-valued quantized data acquired by the second acquisition unit and the dot arrangement pattern group set by the setting unit, wherein the dot arrangement pattern group is set so that the number of the second dot arrangement pattern groups determined for the plurality of pixel regions located at a first position, that is included an end part region of the unit region in the predetermined direction corresponding to an end part of the eject port column in the predetermined direction, in a case where the density of the image indicated by the information acquired by the first acquisition unit is a predetermined value is smaller than the number of the second dot arrangement pattern groups determined for the plurality of pixel regions located at a second position, that is included in the end part region and is closer to an end of the unit region than the first position in the predetermined direction, in a case where the density of the image indicated by the information acquired by the first acquisition unit is the predetermined value, and the number of the first dot arrangement pattern groups determined for the plurality of pixel regions located at the first position in a case where the density of the image indicated by the information acquired by the first acquisition unit is the predetermined value is larger than the number of the first dot arrangement pattern groups determined for the plurality of pixel regions located at the second position in a case where the density of the image indicated by the information acquired by the first acquisition unit is the predetermined value.

Further features of the present invention will become apparent from the following description of exemplary embodiments (with reference to the attached drawings).

### BRIEF DESCRIPTION OF THE DRAWINGS

FIG. 1 is a sectional side elevation explaining a configuration of an ink jet printing apparatus that can be used in the present invention;

FIG. 2 is a diagram in the case where a printing head is viewed from an eject port surface side;

FIG. 3 is a block diagram showing an outline configuration of a control system in an ink jet printing apparatus 2;

FIG. 4 is a diagram explaining image processing of the present invention;

FIG. 5 is a diagram showing an example of a dot arrangement pattern stored in a ROM;

FIG. 6 is a diagram showing a pattern selection table for setting a dot arrangement pattern;

FIGS. 7A and 7B are diagrams showing pattern selection tables for dealing with a joint streak;

FIG. 8 is a diagram showing a table setting matrix α;

FIG. 9 is a diagram showing a table for setting density increase/decrease parameters P from evaluation values;

FIGS. 10A to 10C are diagrams each showing a method for obtaining a pattern table at the time of printing;

FIGS. 11A and 11B are diagrams showing a dot array and a joint streak occurrence state in the case where joint streak correction has not been performed;

FIGS. 12A and 12B are diagrams showing a dot array and a joint streak occurrence state in the case where joint streak correction has been performed;

FIG. 13 is a diagram showing an example of a dot arrangement pattern that is used in the case where a black streak is problematic;

FIGS. 14A and 14B are diagrams showing examples of dot arrangement patterns in the case where a white streak is problematic;

FIGS. 15A and 15B are diagrams showing pattern selection tables of a second embodiment;

FIG. 16 is a diagram showing a method for obtaining a pattern table C;

FIGS. 17A and 17B are diagrams showing pattern selection tables of a third embodiment;

FIG. 18 is a diagram showing a table setting matrix β that is used in the third embodiment;

FIGS. 19A and 19B are diagrams showing pattern selection tables of the third embodiment;

FIG. 20 is a diagram showing a table setting matrix γ that is used in the third embodiment;

FIG. 21 is a diagram showing another example of the table setting matrix;

FIGS. 22A and 22B are diagrams showing other examples of pattern selection tables; and

FIG. 23 is a diagram showing another example of the table setting matrix.

### DESCRIPTION OF THE EMBODIMENTS

Hereinafter, embodiments of the present invention are explained in detail with reference to the drawings.

### <Explanation of Printing Apparatus>

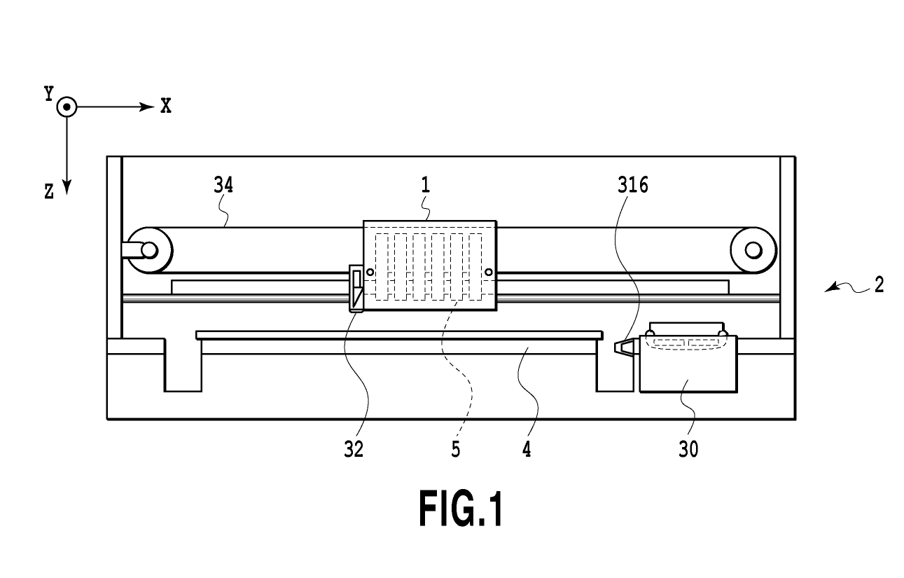

FIG. 1 is a sectional side elevation for explaining a configuration of a printing unit of an ink jet printing apparatus 2 (hereinafter, also referred to simply as a printing apparatus) that can be used in the present invention. A carriage 1 mounting printing heads 5 and an optical sensor 32 is enabled to reciprocate in an X direction in FIG. 1 by a drive force of a carriage motor transmitted via a belt 34. While the carriage 1 is moving relatively in the X direction with respect to a printing medium, the printing head 5 ejects ink in a Z direction in accordance with printing data, and thereby, an image corresponding to one scan is printed on a printing medium arranged on a platen 4. After the one printing scan is completed, the printing medium is conveyed in a Y direction intersecting the X direction in FIG. 1 by a distance corresponding to a printing width of one scan. By alternately repeating the printing scan such as this (a plurality of times of scan) and the conveyance operation, an image is formed gradually on the printing medium.

The optical sensor 32 determines whether or not there exists a printing medium on the platen 4 by performing the detection operation while moving together with the carriage 1. At a position in the scan region of the carriage 1 and apart from the platen 4, a recovery unit 30 configured to perform maintenance processing of the printing head 5 is arranged.

### <Explanation of Printing Head>

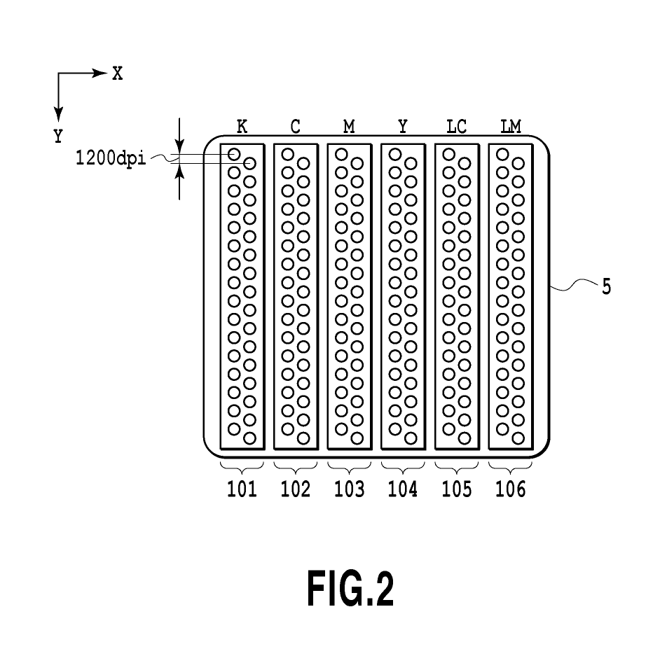

FIG. 2 is a diagram in the case where the printing head 5 is viewed from the eject port surface side. In the printing head 5, six eject port columns 101 to 106 are arranged in parallel in the X direction. In each of the eject port columns 101 to 106, a plurality of eject ports (here, 32 eject ports) for ejecting ink as a droplet is arrayed at a pitch of 1,200 dpi in the Y direction (array direction). The eject port columns 101 to 106 eject black (K), cyan (C), magenta (M), yellow (Y), light cyan (Lc), and light magenta (Lm) inks, respectively.

### <Explanation of Control Unit>

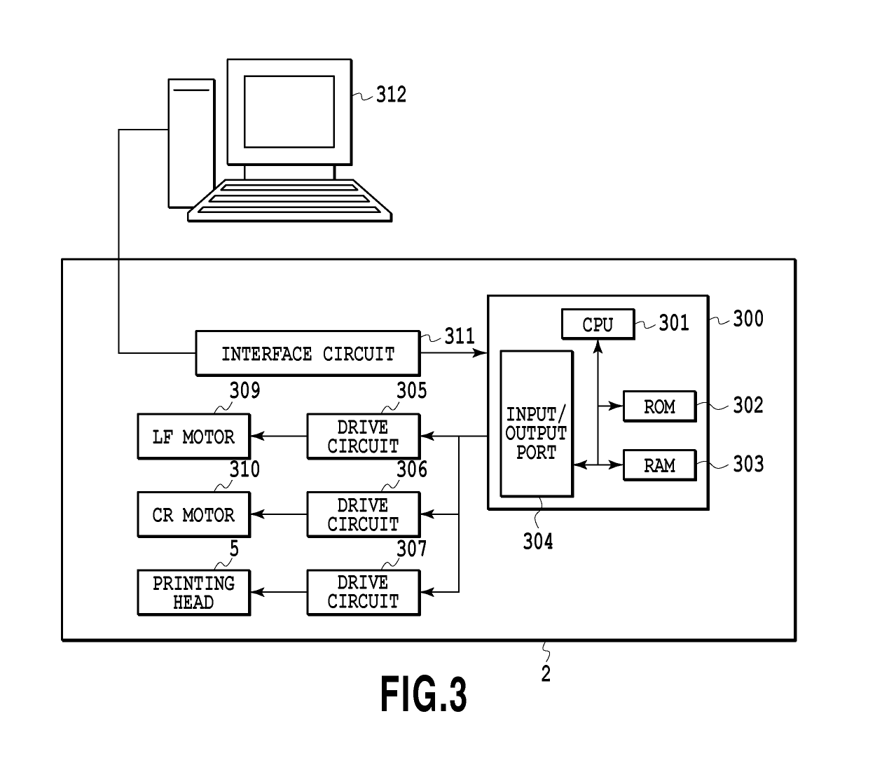

FIG. 3 is a block diagram showing an outline configuration (printing control apparatus) of a control system in the ink jet printing apparatus 2. A main control unit 300 includes a CPU 301 that performs processing operations, such as arithmetic operation, selection, determination, and control, a ROM 302 storing programs etc. to be executed by the CPU 301, a RAM 303 used as a buffer etc. of printing data, an input/output port 304, etc. Various tables, to be described later, characteristic to the present invention are also stored in the ROM 302. To the input/output port 304, drive circuits 305, 306, and 307 for driving an LF motor 309 for controlling the conveyance of the printing medium, a CR motor 310 for controlling the printing scan by causing the carriage 1 to reciprocate, and each of the printing heads 5 respectively are connected. Further, these components are also connected to a host computer 312 via an interface circuit 311. The characteristic control of the present invention that will be explained below is performed by a printer driver installed in the host computer 312 or performed by the CPU 301 of the printing apparatus 2 in accordance with the programs and various kinds of parameters stored in the ROM 302.

### <Explanation of Printing Data Generation Processing>

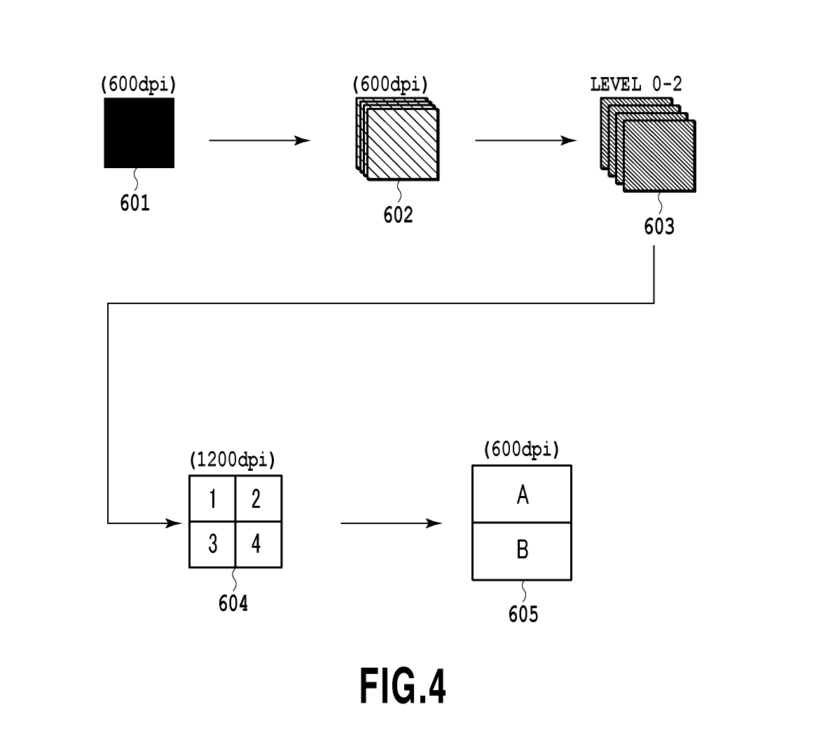

FIG. 4 is a diagram explaining conversion processing of image data performed by the host computer 312 and the control unit 300 of the printing apparatus 2. Original image data 601 is 600 dpi RGB data and the printer driver first converts the image data 601 into 600 dpi density data 602 corresponding to the ink colors CMYKLcLm used by the printing apparatus 2. After that, by using the multivalued error diffusion method or the dither method, the density data 602 of each of CMYKLcLm is converted into quantized data 603 having three levels of 0 to 2. Here, quantization into three-valued data is shown as an example, but a number N of values for quantization is not limited to three. The host computer 312 transfers the quantized data of each color in this state to the printing apparatus 2.

The CPU 301 having received the three-valued image data converts the 600 dpi quantized data 603 into 1,200 dpi binary printing data 604 in accordance with the level value (number of gradations) by referring to a dot arrangement pattern stored in the ROM 302 in advance. Further, after performing processing characteristic to the present invention, as will be described later, the printing data is accumulated in a print buffer prepared within the RAM 303. The printing data is binary data that determines printing (1) or non-printing (0) for each of 2×2 pixels arrayed in 1,200 dpi.

After the printing data corresponding to one or more scans is accumulated in the RAM 303, the CPU 301 performs a printing operation based on the printing data 604 in accordance with the program stored in the ROM 302. Specifically, the CPU 301 causes the printing head 5 to perform the eject operation while reading the binary printing data 604 by an amount corresponding to one scan each time. At this time, the printing resolution in the main scan direction (X direction) may be set to 1,200 dpi, but it may also be set to 600 dpi. In the case of 600 dpi, the dots corresponding to printing data 1 and 2 put side by side in the main scan direction are printed repeatedly at a pixel position A as is known by referring to printing results 605. Dots corresponding to printing data 3 and 4 are printed repeatedly at a pixel position B. The CPU 301 prints an image corresponding to one page on a printing medium by causing the printing head 5 to perform the eject operation in accordance with the printing data 604 while controlling the drive of the various kinds of motors as required via the input/output port 304. Several embodiments that can be adopted in the present invention will be explained below by using the printing system explained above.

### First Embodiment

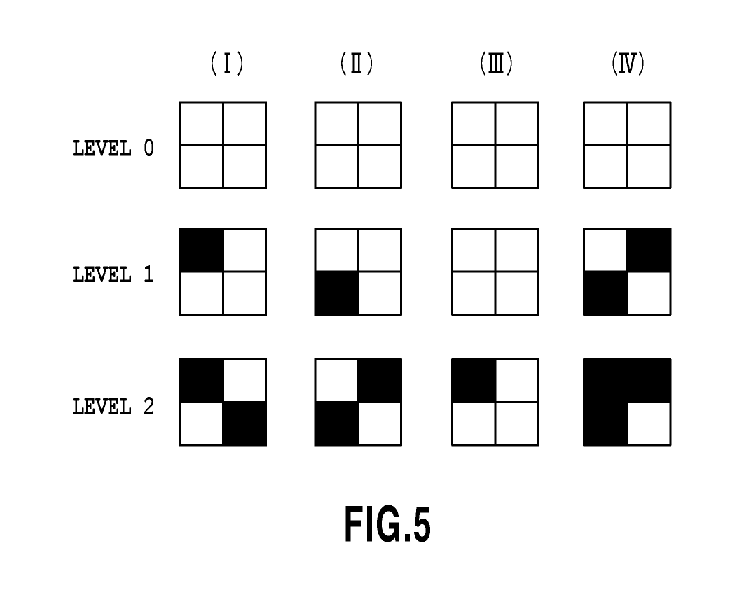

FIG. 5 is a diagram showing an example of a dot arrangement pattern stored in the ROM 302. The CPU 301 selects a dot arrangement pattern in which printing of dots (black) or non-printing of dots (white) is determined for each of 2×2 areas corresponding to a pixel region in accordance with 600 dpi quantized data indicating any of levels 0 to 2. Usually, the number of dots that are printed in the 2×2 areas corresponding to the pixel regions increases as the level number increases, and here, four kinds of dot arrangement pattern groups I to IV in which the way the number of dots increases is different from one another are prepared. Hereinafter, the contents of the dot arrangement patterns I to IV are explained specifically.

As to level 0, the number of printing pixels (area represented in black) is zero in all the dot arrangement patterns I to IV. As to level 1, the number of printing pixels is one in the patterns I and II, that is zero in the pattern III, and that is two in the pattern IV. As to level 2, the number of printing pixels is two in the patterns I and II, that is one in the pattern III, and that is three in the pattern IV. By comparing the four kinds of patterns, it is known that in the patterns I and II, the number of printing pixels increases in regular order as the level number increases, but in the pattern III, the number of printing pixels is made less than that in the patterns I and II and in the pattern IV, the number of printing pixels is increased compared to that in the patterns I and II. It is known that the power of low frequency components in the frequency region included in the binary data generated by using the pattern III is larger than the power of low frequency components in the frequency region included in the binary data generated by using the patterns I and II. Further, it is also known that the power of high frequency components in the frequency region included in the binary data generated by using the pattern IV is larger than the power of high frequency components in the frequency region included in the binary data generated by using the patterns I and II. In the present specification, the pattern in which the number of printing pixels increases in regular order as the level number increases, as the patterns I and II, is referred to as a first dot arrangement pattern. The pattern in which the number of printing pixels is larger or smaller than that of the first dot arrangement pattern, such as the pattern III and the pattern IV, is referred to as a second dot arrangement pattern. In the present embodiment, these four kinds of dot arrangement patterns are prepared and at the boundary part where the black streak is comparatively apt to be conspicuous, the binarization processing is performed by using the pattern III in order to make the black streak no longer conspicuous by suppressing the number of dots. At the boundary part where the white streak is comparatively apt to be conspicuous, the binarization processing is performed by using the pattern IV in order to make the white streak no longer conspicuous by increasing the number of dots.

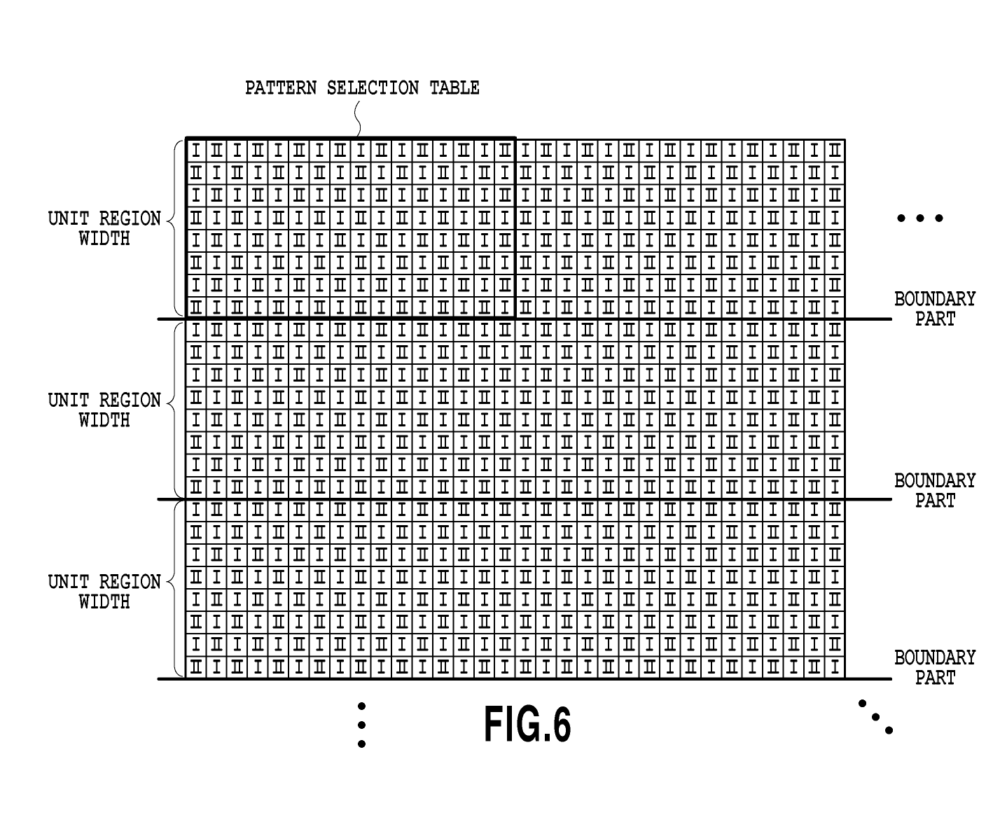

FIG. 6 is a diagram showing a pattern selection table for setting a dot arrangement pattern that is used in each of the pixels arrayed in 600 dpi. Here, in order to make explanation simple, the case is shown where one-pass printing is performed for a unit region on a printing medium by using each 16 eject ports of each eject port column. In this case, in the printing scan performed once, the 600 dpi unit region having a width of eight pixels in the Y direction is printed and in FIG. 6, the width in the Y direction of the unit region that is printed by the printing scan performed once is shown as a unit region width and the boundary part between each printing scan is shown as a boundary part between the unit regions. In FIG. 6, the pattern selection table has the region including eight pixels that agrees with the unit region width in the Y direction and 16 pixels in the X direction, and the pattern I or II is set in all the pixels within the pattern selection table. The pattern selection table such as this is used repeatedly in the X direction (main scan direction) and in the Y direction (sub scan direction).

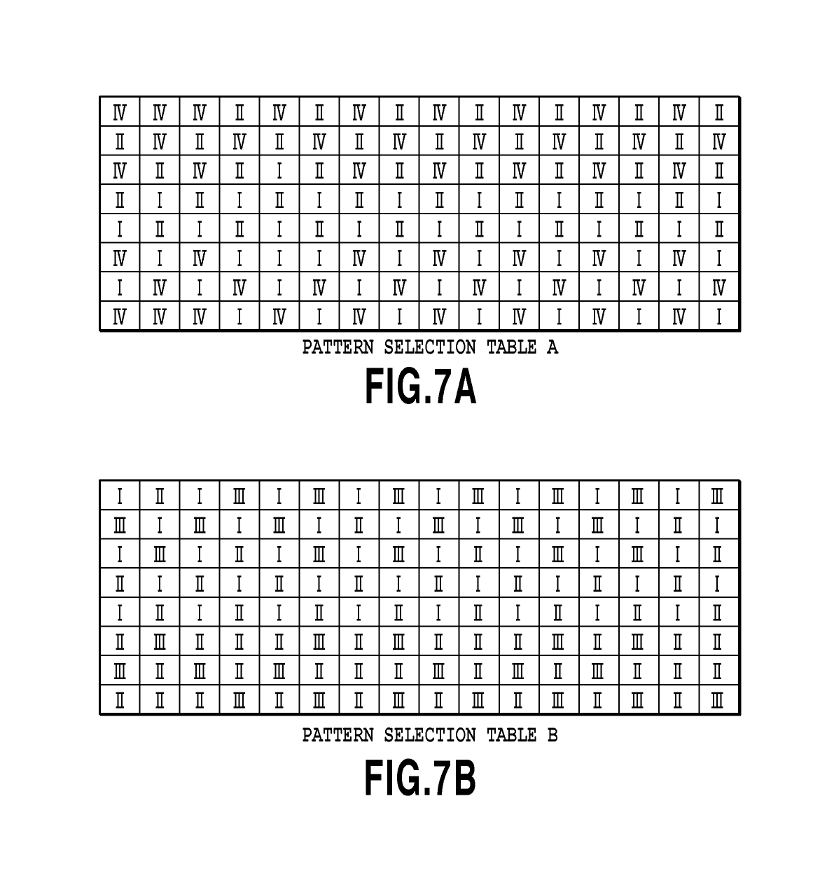

FIGS. 7A and 7B are diagrams showing pattern selection tables A and B for dealing with the joint streak that are used in the present embodiment. In the pattern selection table A shown in FIG. 7A, in the three-pixel width at the upper end and the lower end, the patterns I, II, and IV are set and in the two-pixel width at center except for the upper end and the lower end, the patterns I and II are set alternately. The three-pixel width at the upper end corresponds to six eject ports arranged at one end of the eject port column and the three-pixel width at the lower end corresponds to six eject ports arranged at the other end of the eject port column. Then, the region that is printed by the eject ports at the lower end in the first printing scan performed earlier of the printing scans performed twice successively, and the region that is printed by the eject ports at the upper end in the second printing scan performed following the first printing scan are arranged adjacent to each other and the boundary there between forms the boundary part.

n the case where the pattern selection table A is used, in the three-pixel widths at the upper end and the lower end, printing is performed with more dots increased by addition than those at the center as a result. In other words, the pattern selection table A will be a table effective in the case where the white streak is conspicuous in the vicinity of the boundary between the region that is printed by the eject ports at the lower end in the first printing scan and the region that is printed by the eject ports at the upper end in the second printing scan.

On the other hand, in the pattern selection table B shown in FIG. 7B, in the three-pixel widths at the upper end and the lower end, the patterns I, II, and III are set and in the two-pixel width at the center except for the upper end and the lower end, the patterns I and II are set. In the case where the pattern selection table B such as this is used, in the three-pixel widths at the upper end and the lower end, printing is performed with less dots decreased by reduction than those at the center as a result. In other words, the pattern selection table B will be a table effective in the case where the black streak is conspicuous in the vicinity of the boundary between the region that is printed by the eject ports at the lower end in the first printing scan and the region that is printed by the eject ports at the upper end in the second printing scan.

The conspicuity of the black streak or the white streak is varies in accordance with the image density. For example, even in the case where printing is performed on the same printing medium by using the same ink, the black streak that is conspicuous in the low density may be less conspicuous in the high density. In such circumstances, in the case where the pattern selection table B shown in FIG. 7B is used at all times in order to reduce the black streak, dots are thinned uniformly by the dot arrangement pattern III for both level 1 and level 2. As a result of that, in the region configured mainly by level 2 where the density is high, there is a possibility that the white streak will occur due to excessive correction. In other words, preferably, whether to use the pattern selection table A or the pattern selection table B is adjusted in accordance with the gradation value of each pixel.

Further, as is already explained in the section of the background of the invention, the intensity of the streak (i.e., density) in range in which the joint streak appears (thickness of the joint streak) is not uniform. Specifically, the intensity of the joint streak is the highest at the boundary between the printing scan that is performed earlier on the printing medium and the printing scan that is performed following the previous printing scan and the intensity thereof becomes lower at a position more distant from the boundary in the conveyance direction. In other words, an appropriate ratio of adding or reducing dots in order to make the joint streak less conspicuous varies depending on the position even in the same range in which the joint streak appears. Consequently, preferably, whether the pattern selection table A or B is used is also determined in accordance with the position of each pixel. In view of the above, in the present embodiment, a table setting matrix and a density increase/decrease parameter P for selecting an appropriate dot arrangement pattern in accordance with the gradation value and the position of the pixel are prepared.

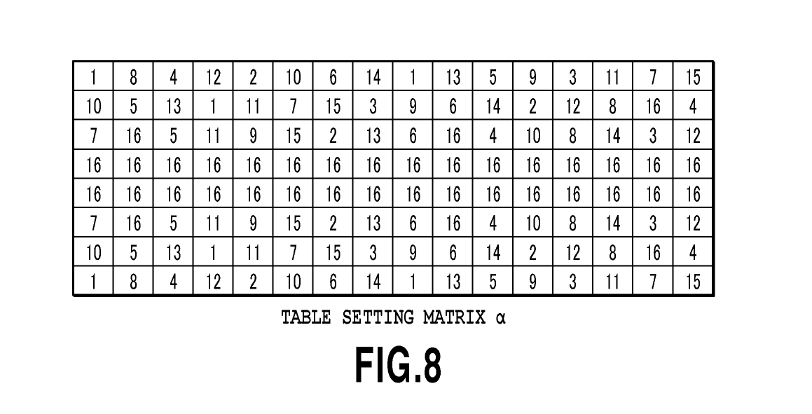

FIG. 8 is a diagram showing a table setting matrix α that is used in the present embodiment. The table setting matrix α has the same region as that of the pattern selection tables A and B, i.e., the region of 16 pixels in the main scan direction×eight pixels in the sub scan direction and in individual pixels, parameters 1 to 16 are allocated as in FIG. 8. In each pixel in the three-pixel width at the upper end and in the three-pixel width at the lower end, one and the different one of parameters 1 to 16 is allocated and in the two-pixel width region at the center, 16 is allocated uniformly.

In the present embodiment, each parameter in the table setting matrix α is compared with the density increase/decrease parameter P. Then, based on the relationship in magnitude between both, whether the dot arrangement pattern is set in accordance with the pattern selection table A or the dot arrangement pattern is set in accordance with the pattern selection table B is determined. By doing so, it is possible to adjust the ratio in which the pattern selection table A and the pattern selection table B are set in the three-pixel widths at the upper end and the lower end that affect the joint streak by setting the density increase/decrease parameter P large or small.

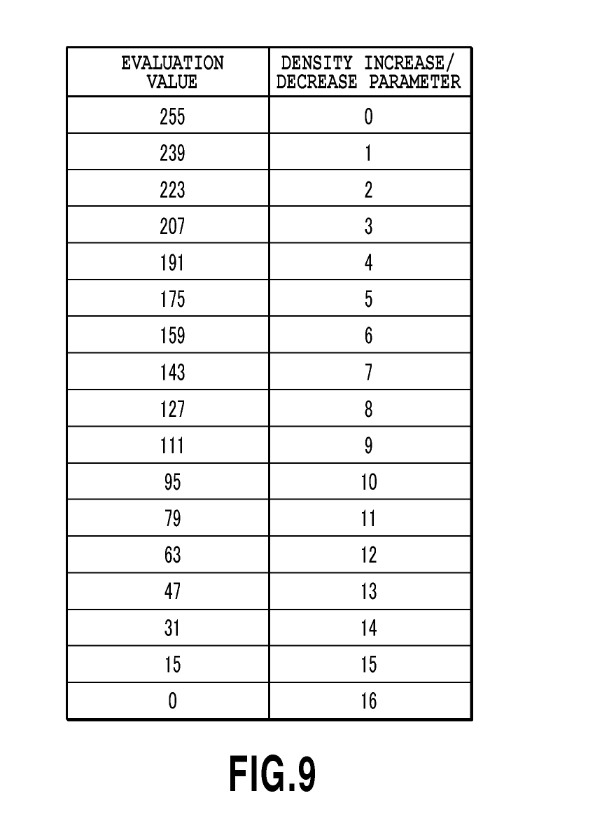

At this time, it is sufficient for the value of the density increase/decrease parameter P to be set in accordance with the conspicuity of the joint streak and the setting method is not limited in particular. In the present embodiment, it is sufficient to adjust the value of the density increase/decrease parameter P so that the more conspicuous the white streak, the more the pattern selection tables A are set and the more conspicuous the black streak, the more the pattern selection tables B are set in an image that is printed. The conspicuity of the white streak or the black streak can be determined by, for example, the L*a*b* value of the original image data, but it is also possible to use the density data 602 of each ink color in each pixel as the evaluation value. FIG. 9 is a diagram of a table for indicating a relationship of correspondence between the black density data and the density increase/decrease parameter P in the case where the density data 602 of black K is used as the evaluation value as an example. Here, both are associated with each other so that the higher the density value of black (0 to 255), the lower the value of the density increase/decrease parameter P (0-16).

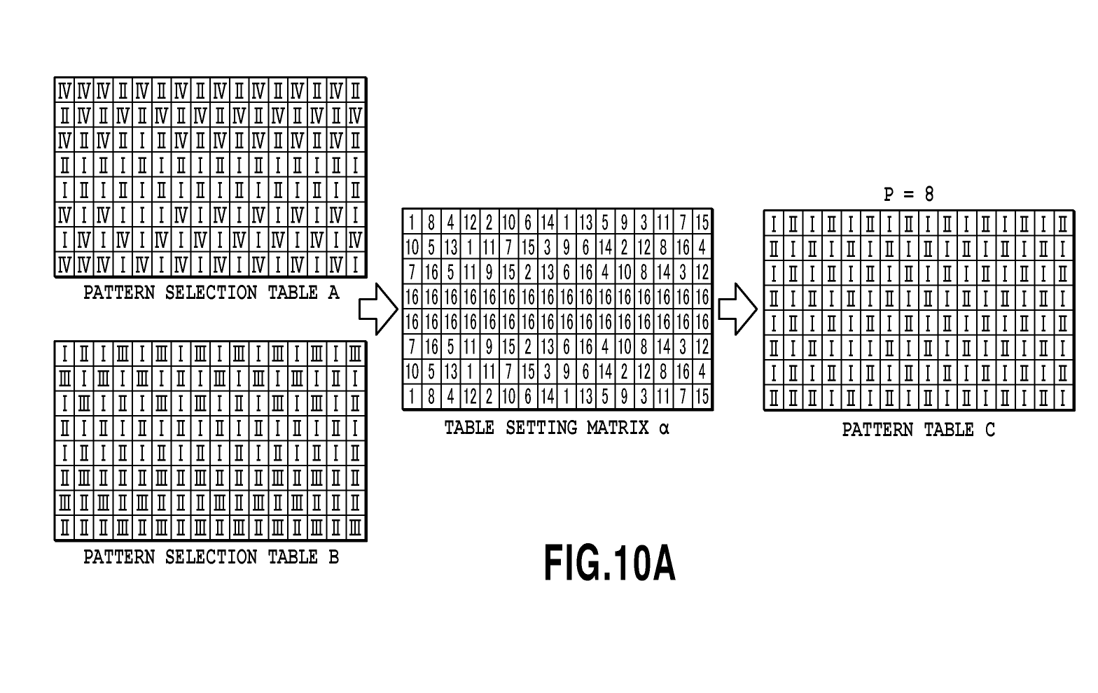

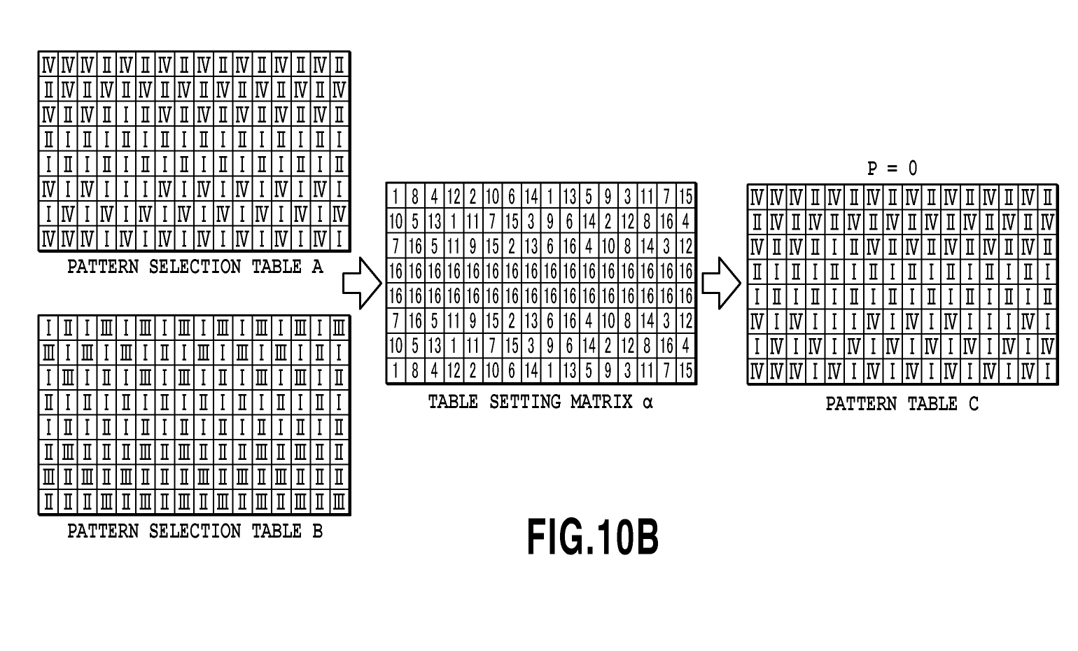

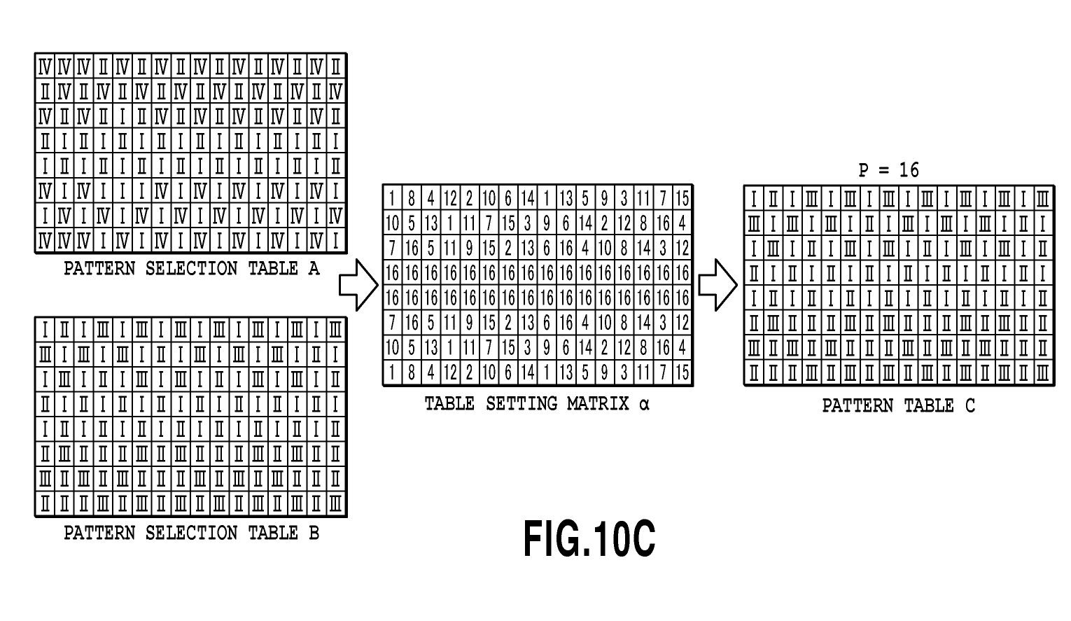

FIGS. 10A to 10C are diagrams each explaining a method for obtaining a pattern table C that is used actually at the time of printing from the table setting matrix α shown in FIG. 8 and the density increase/decrease parameter P. FIG. 10A is a diagram showing the case where the density increase/decrease parameter P is set to “8”.

In the present embodiment, the dot arrangement pattern that is used in each pixel is determined by comparing the parameter set for each pixel by the table setting matrix α with the density increase/decrease parameter P. Specifically, in the case where the parameter of the table setting matrix α is larger than the density increase/decrease parameter P, to the pixel, the dot arrangement pattern set to the corresponding pixel of the pattern selection table A is allocated. On the other hand, in the case where the parameter of the table setting matrix α is equal to or smaller than the density increase/decrease parameter P, to the pixel, the dot arrangement pattern set to the corresponding pixel of the pattern selection table B is allocated.

For example, in the two pixel rows at the center of the table setting matrix α, the parameter is uniformly “16” and this is larger than the density increase/decrease parameter P=“8”. Consequently, in this region, the dot arrangement patterns set in the corresponding region of the pattern selection table A are set exactly in accordance with the array. On the other hand, the parameters in the three pixel row regions from the upper and lower ends of the table setting matrix α are “1” to “16” and half the parameters are larger than the density increase/decrease parameter P=“8” but the remaining half are equal to or less than the density increase/decrease parameter P=“8”. Because of this, in this region, in the pixels in which the parameter is larger than P=“8”, the dot arrangement patterns I and II set in the pattern selection table A are set. Further, in the pixels in which the parameter is equal to or less than P=“8”, the dot arrangement patterns I and II set in the pattern selection table B are set. As a result, in the case where the density increase/decrease parameter P=“8”, the dot arrangement pattern I or II is set in all the regions.

Here, referring to FIG. 5 again, the dot arrangement patterns I and II of the present embodiment are patterns that do not cause the addition or reduction of dots. That is, in the case where the density increase/decrease parameter P=“8”, the dot arrangement pattern I or II is used uniformly both in the boundary region and in the non-boundary region and no dots are added to or reduced from the boundary region. In other words, in the case of the condition under which the white streak or the black streak is not conspicuous in particular, the density increase/decrease parameter P is set to “8” in the present embodiment. Then, in the table setting matrix α and in the pattern selection tables A and B, in the case where the density increase/decrease parameter P=“8”, the parameters of the individual pixels are set so that the dot arrangement patterns I and II are arranged substantially alternately in all the pixel regions.

On the other hand, FIG. 10B is a diagram showing the case where the density increase/decrease parameter P is set to “0” in all the pixels. The table setting matrix α and the pattern selection tables A and B are the same as those in FIG. 10A. In the region except for the three pixel rows at the upper and lower ends of the table setting matrix α, the parameters are uniformly “16” and are larger than the density increase/decrease parameter “0”. Because of this, in this region, as in FIG. 10A, the dot arrangement patterns I and II set in the corresponding region of the pattern selection table A are set exactly in accordance with the array. On the other hand, the parameters in the three pixel row regions at the upper and lower ends of the table setting matrix α are any of “1” to “16” and in all the pixels, parameters are larger than the density increase/decrease parameter P=“0”. Because of this, in these regions, the dot arrangement pattern I, II, or IV is allocated in accordance with the pattern selection table A in all the pixels. In other words, the pattern table C that is used actually at the time of printing will be the same as the pattern selection table A.

Here, referring to FIG. 5 again, the dot arrangement pattern IV that is arranged in the three pixel rows at the upper and lower ends is a pattern that causes the addition of dots. That is, in the case where the density increase/decrease parameter P=“0”, correction is performed so as to add dots to the end part regions. Further, the table setting matrix α in the present embodiment is set so that the number of pixel in which the dot arrangement patterns IV is arranged increases as the density increase/decrease parameter decreases in the range in which the density increase/decrease parameter is 0 to 8. Consequently, it is designed so that as the white streak becomes more apt to be conspicuous, i.e., as the density increase/decrease parameter approaches 0 (image density is high), the number of dots that are added to the end part region increases.

Further, FIG. 10C is a diagram showing the case where the density increase/decrease parameter P is set to “16” in all the pixels. The table setting matrix α and the pattern selection tables are the same as those in FIG. 10A. In the region except for the three pixel rows at the upper and lower ends of the table setting matrix α, the parameters are uniformly “16” and are equal to the density increase/decrease parameter “16”. Because of this, in this region, as in FIG. 10A, the dot arrangement patterns I and II set in the corresponding region of the pattern selection table A are set exactly in accordance with the array. On the other hand, the parameters in the three pixel row regions at the upper and lower ends of the table setting matrix α are any of “1” to “16” and in all the pixels, the parameters are equal to or less than the density increase/decrease parameter “16”. Because of this, in these regions, the dot arrangement patterns I, II, and III are allocated in accordance with the pattern selection table B in all the pixels.

Here, referring to FIG. 5 again, the dot arrangement pattern III that is arranged in the three pixel rows at the upper and lower ends is a pattern that causes the reduction of dots. That is, in the case where the density increase/decrease parameter is “16”, correction is performed so as to reduce dots in the end part regions. Further, the table setting matrix α in the present embodiment is set so that the number of pixel in which the dot arrangement patterns III is arranged increases as the density increase/decrease parameter increases in the range in which the density increase/decrease parameter is 9 to 16. Consequently, it is designed so that as the black streak becomes more apt to be conspicuous, i.e., as the density increase/decrease parameter approaches 16, the number of dots that are reduced from the end part region increases.

As above, according to the present embodiment, it is made possible to adjust the addition or reduction of dots in accordance with conspicuity of the black streak and the white streak while using one set of the table setting matrix α and the pattern selection tables A and B in order to that the black streak and the white streak are no longer conspicuous.

Here, by referring to the table setting matrix α shown in FIG. 8 again, the characteristic parameter distribution in the present embodiment is explained. In the three pixel rows at the upper and lower ends, in the first pixel rows at the uppermost end and the lowermost end, the number of pixels in which the parameter is set to “1” of the 16 pixels in total is two, respectively, the number of pixels in which the parameter is set to one and the different one of “2” to “15” is one, respectively, and the number of pixels in which the parameter is set to “16” is zero. In the second pixel rows from the uppermost end and the lowermost end, there exists one pixel, respectively, in which the parameter is set to one and the different one of “1” to “16”. Further, in the third pixel rows from the uppermost end and the lowermost end, there is no pixel in which the parameter is set to 1, and there exists one pixel, respectively, in which the parameter is set to one and the different one of 2 to 15 and there exist two pixels in which the parameter is set to “16”. In the case where the table setting matrix α such as this is used, regardless of the value of the density increase/decrease parameter P, the number of pixels in which a parameter smaller than the density increase/decrease parameter P is set is the largest in the first pixel rows at the uppermost end and the lowermost end, and the number of such pixels decreases in the order from the second row and the third row. In other words, by using the table setting matrix α, a ratio in which the pattern selection table A and the pattern selection table B are set in each pixel row changes stepwise for each pixel row.

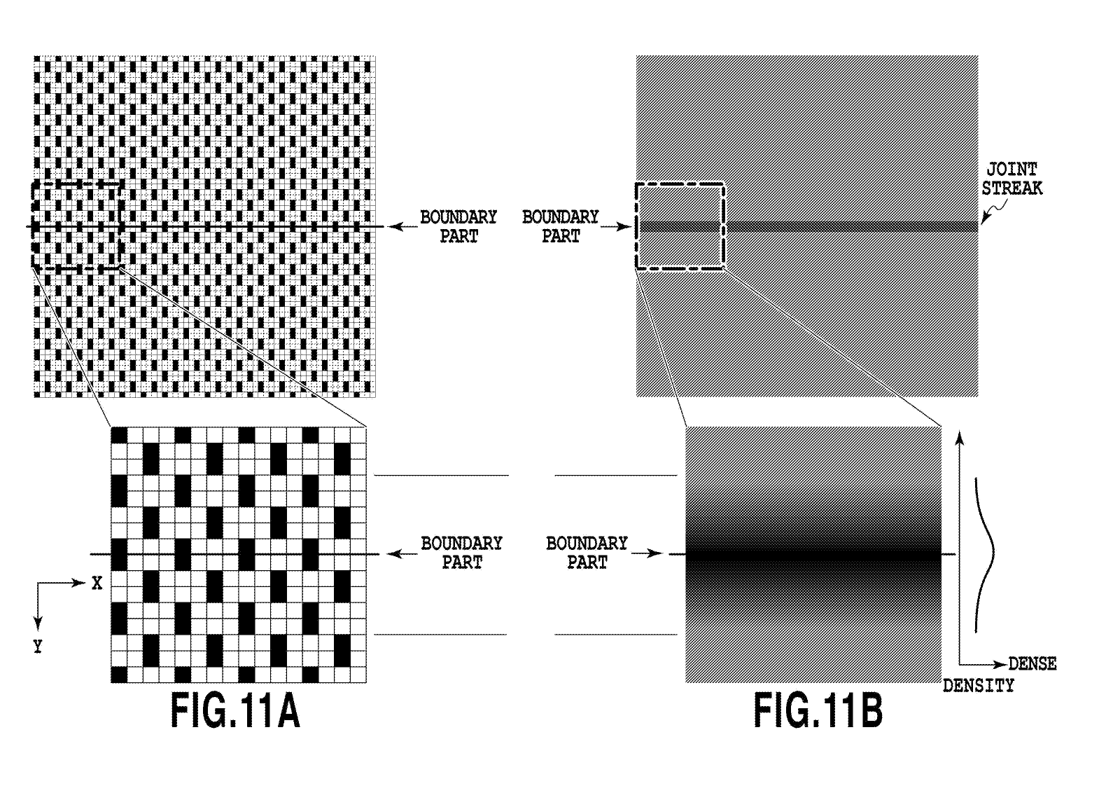

FIGS. 11A and 11B are diagrams showing a dot array and a joint streak occurrence state caused by a first printing scan and a second printing scan on a predetermined printing medium in the case where each pixel is at about level 1 in FIG. 5. FIG. 11A shows a dot arrangement pattern in the case where correction processing to reduce the joint streak has not been performed and the pattern (I) and the pattern (II) at level 1 are arrayed alternately in all the pixels, together with an enlarged view. FIG. 11B shows the black streak that occurs in the case where dots are printed as in FIG. 11A and an enlarged view thereof. Referring to both the enlarged views in FIGS. 11A and 11B, the region that appears as the black streak in this example includes a region corresponding to ten pixels in 1,200 dpi, i.e., five pixels in 600 dpi. In other words, in order to eliminate the black streak such as this, it is necessary to replace some of the patterns I and II shown in FIG. 5 with the pattern III in the three pixel regions at the upper and lower ends in each printing scan.

Here, by referring to the enlarged view in FIG. 11B, it is known that the position where the black streak appears most intensive (i.e., the density is high) is the boundary part between the first printing scan and the second printing scan and the density becomes lower as the distance in the conveyance direction (Y direction) from the boundary part increases. Consequently, in a case where dots are reduced in a fixed ratio from the correction regions having a width of about three pixels at the upper and lower ends, there is a possibility that the joint streak will not be eliminated sufficiently. For example, in a case where dots are reduced in a ratio adjusted for the position of the boundary part whose density is the highest, in the region three pixels apart in the conveyance direction from the boundary part, the density becomes too low and there arises a possibility that the white streak will appear. On the other hand, in a case where dots are reduced in a ratio adjusted for the region three pixels apart in the conveyance direction from the boundary part, the density is not reduced sufficiently at the boundary part and there arises a possibility that the black streak will be left.

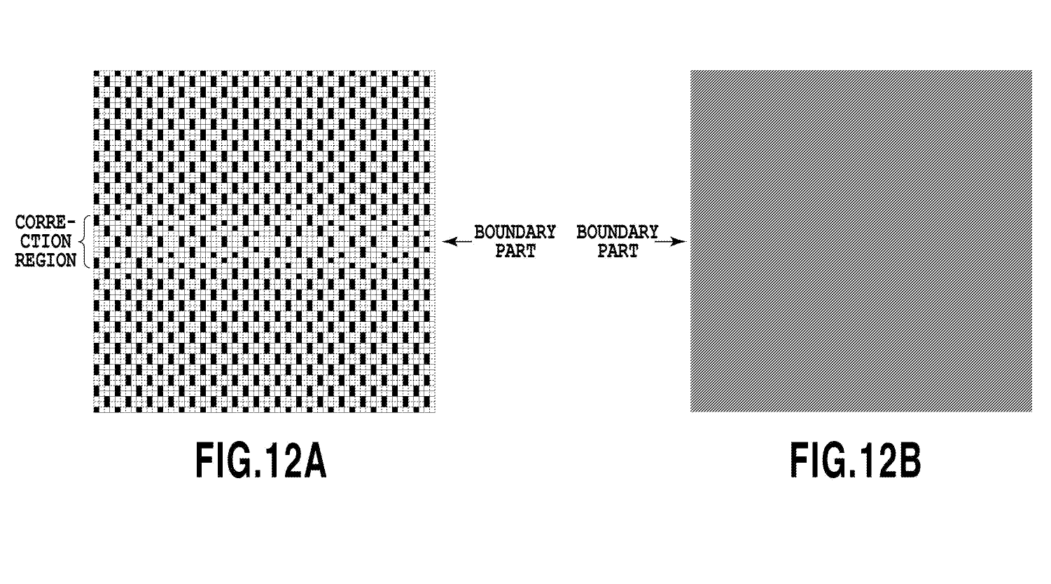

FIGS. 12A and 12B are diagrams showing a dot array and a joint streak occurrence state in the case where the joint streak correction of the present embodiment has been performed in FIGS. 11A and 11B. In the present embodiment, the table setting matrix α explained in FIG. 8 is used, and therefore, the number of pixels in which the pattern III is set is the largest in the pixel row adjacent to the boundary part and the number of such pixels decreases as the distance from the boundary part increases. Because of this, the number of printing pixels is the smallest in the vicinity of the boundary part and increases gradually as the distance from the boundary part increases as is seen in FIG. 12A. As a result, the number of dots is decreased in an appropriate ratio in each pixel row, and therefore, as is seen in FIG. 12B, it is possible to output a uniform image with no difference in density in the three pixel regions at the upper and lower ends from the boundary part, i.e., in all the region where correction has been performed.

### Second Embodiment

In the first embodiment, the configuration is explained in which by adjusting the density increase/decrease parameter P in the range of 1 to 16, the increase/decrease of dots is adjusted and thus both the black streak and the white streak can be dealt with. However, in the printing apparatus, only the white streak or only the black streak is problematic in many cases, and in such cases, it is sufficient to deal with one of them.

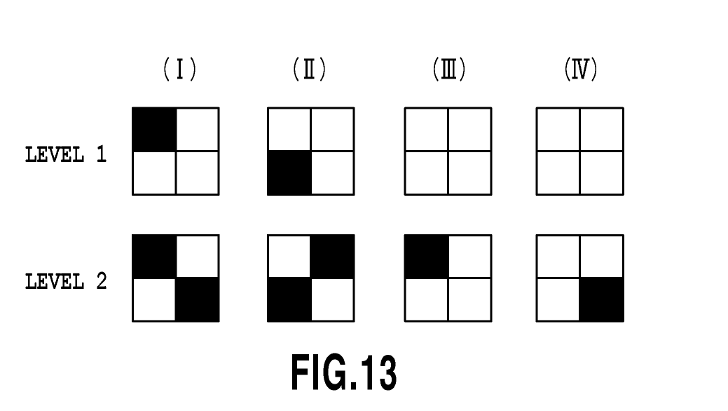

FIG. 13 is a diagram showing an example of a dot arrangement pattern that is used in the case where only the black streak is problematic. At level 1, the number of printing pixels of the patterns I and II is one but the number of printing pixels of the patterns III and IV is zero. At level 2, the number of printing pixels of the patterns I and II is two, but the number of printing pixels of the patterns III and IV is one. In the pattern I and in the pattern II, the number of printing pixels for each level is the same, and in the pattern III and in the pattern IV, the number of printing pixels for each level is also the same, but the positions of the printing pixels are different therebetween.

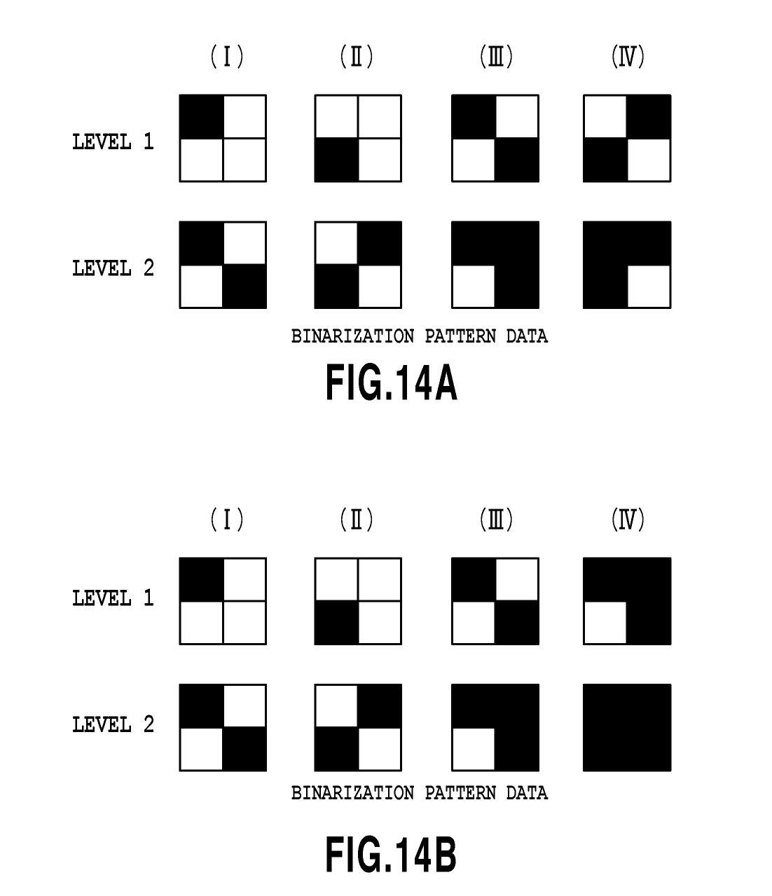

On the other hand, FIGS. 14A and 14B are diagrams showing examples of dot arrangement patterns that are used in the case where only the white streak is problematic. Both in FIG. 14A and in FIG. 14B, the number of printing pixels of the pattern III and the pattern IV is larger than the number of printing pixels of the pattern I and the pattern II for each level. However, in the dot arrangement pattern in FIG. 14A, the number of printing pixels of the pattern III and that of the pattern IV are the same at each level, but in the dot arrangement pattern in FIG. 14B, the number of printing pixels of the pattern IV is larger than that of the pattern III. By preparing the dot arrangement pattern as in FIG. 14B, it is possible to suppress the white streak by increasing dots more positively compared to the case where the dot arrangement pattern in FIG. 14A is used.

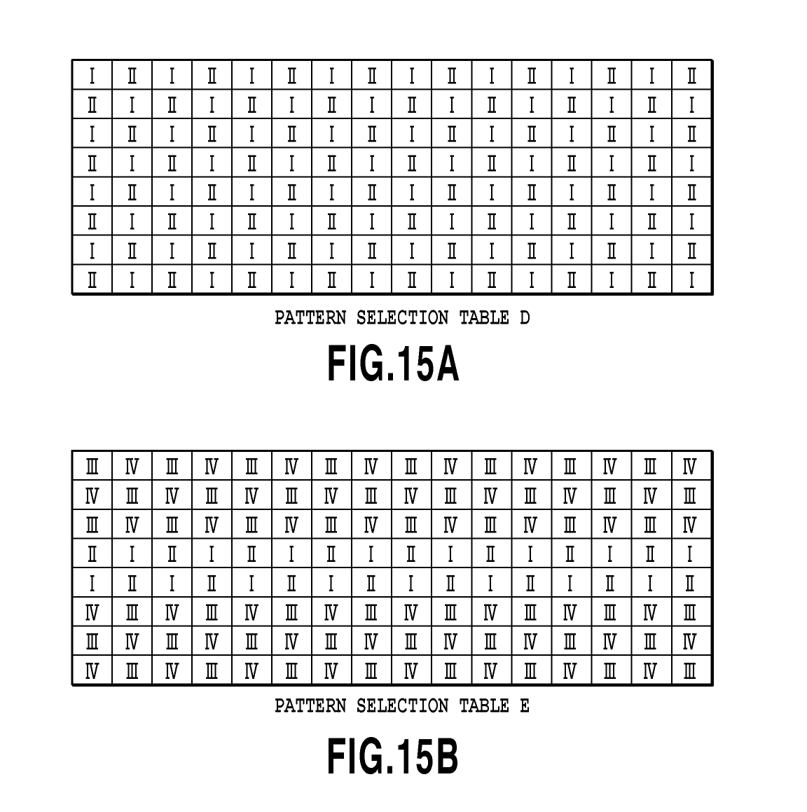

FIGS. 15A and 15B are diagrams showing pattern selection tables D and E that can be used together with each of the dot arrangement patterns shown in FIGS. 13, 14A, and 14B. In the pattern selection table D in FIG. 15A, in all the pixel regions, the patterns I and II are allocated alternately. In the case where the pattern selection table D is used together with the dot arrangement patterns shown in FIGS. 13, 14A, and 14B, dots are not increased or decreased in all the regions.

On the other hand, in the pattern selection table E shown in FIG. 15B, in the three-pixel width at the upper end and in the three-pixel width at the lower end, the patterns III and IV are set alternately and in the two-pixel width except for the upper end and the lower end, the patterns I and II are set alternately. In the case where the pattern selection table E is used together with the dot arrangement patterns shown in FIGS. 13, 14A, and 14B, in the three-pixel widths at the upper end and the lower end, printing is performed with more dots increased by addition or less dots decreased by reduction than those at the center.

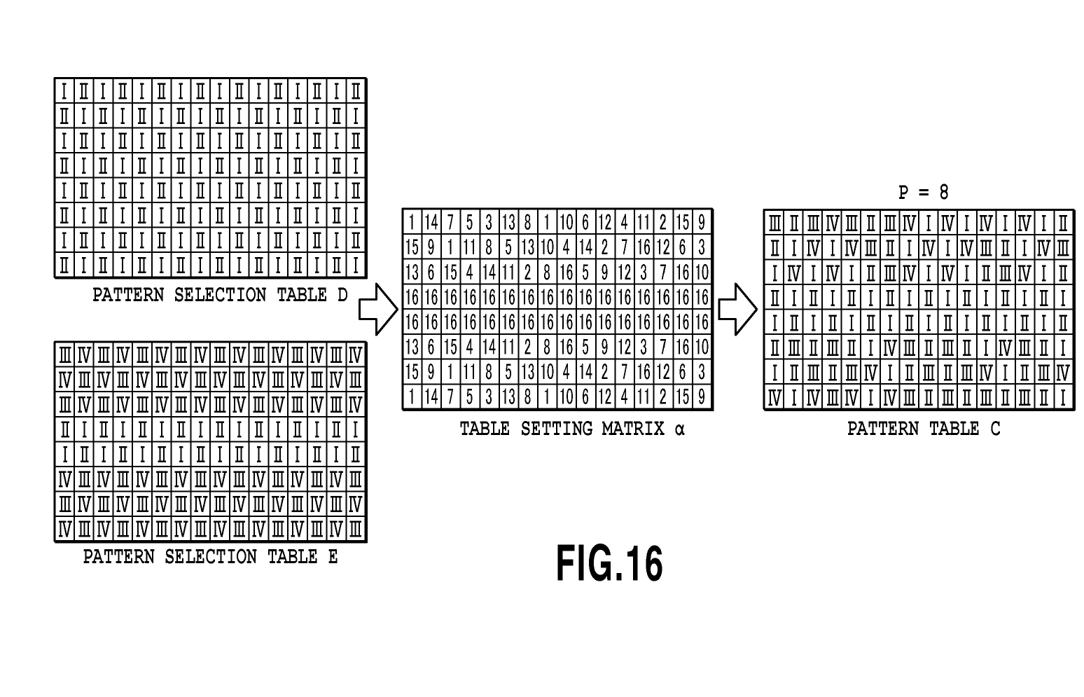

In the present embodiment also, it is possible to use the table setting matrix α shown in FIG. 8. FIG. 16 is a diagram showing a method for obtaining the pattern table C by using the table setting matrix α in the case where the density increase/decrease parameter is set to “8”, as in FIG. 10A. At this time, for example, in the case where the black streak occurs, by using the dot arrangement pattern shown in FIG. 13, dots are reduced in the three-pixel width regions at the upper and lower ends, and therefore, it is possible to make the black streak no longer conspicuous. In the case where the white streak occurs, by using the dot arrangement pattern shown in FIG. 14A or FIG. 14B, dots are added in the three-pixel width regions at the upper and lower ends, and therefore, it is possible to make the white streak no longer conspicuous.

In the table setting matrix α, as explained already, parameters in each pixel row are set such that the number of parameters smaller than the density increase/decrease parameter P decreases in the order from the first pixel rows at the upper and lower ends. Consequently, the number of pixels in which the pattern III or IV is set is the largest in the pixel row adjacent to the boundary part and the number of such pixels decreases as the pixel row becomes more distant from the boundary part. As a result, the ratio of the increase/decrease of dots is higher in the pixel row closer to the boundary part where the intensity of the joint streak is high and the ratio decreases as the pixel row becomes more distant from the boundary, and therefore, it is made possible to output a uniform image with no difference in density in all the regions including the boundary part.

In the present embodiment, both in the case where the black streak is reduced and in the case where the white streak is reduced, it is sufficient to set the value of the density increase/decrease parameter P to a smaller value in order to increase the ratio of the addition or reduction of dots. For example, in the case where the density data 602 of the black K is used as the evaluation value as in the first embodiment for the purpose of reducing the white streak, the larger the evaluation value, the less the white streak becomes apt to be conspicuous. Therefore, in this case, in contrast to FIG. 9, it is sufficient to set the density increase/decrease parameter P to a larger value for a larger evaluation value.

### Third Embodiment

In the above-described embodiment, explanation is given by using the configuration in which the number of dots is adjusted on both sides of the region, i.e., in the three pixel rows at the upper end and in the three-pixel width at the lower end. However, in the printing scans performed twice successively, the joint streak does not necessarily appear in symmetry with respect to the boundary part as a center. There is a case where the joint streak appears at a position above the boundary part or a case where the joint streak appears at a position below the boundary part. In view of such circumstances, in the present embodiment, a configuration is explained, in which a correction width is set at only one of the upper end and the lower end of the eject port column (i.e., at only one of the upper end and the lower end of the pattern selection table).

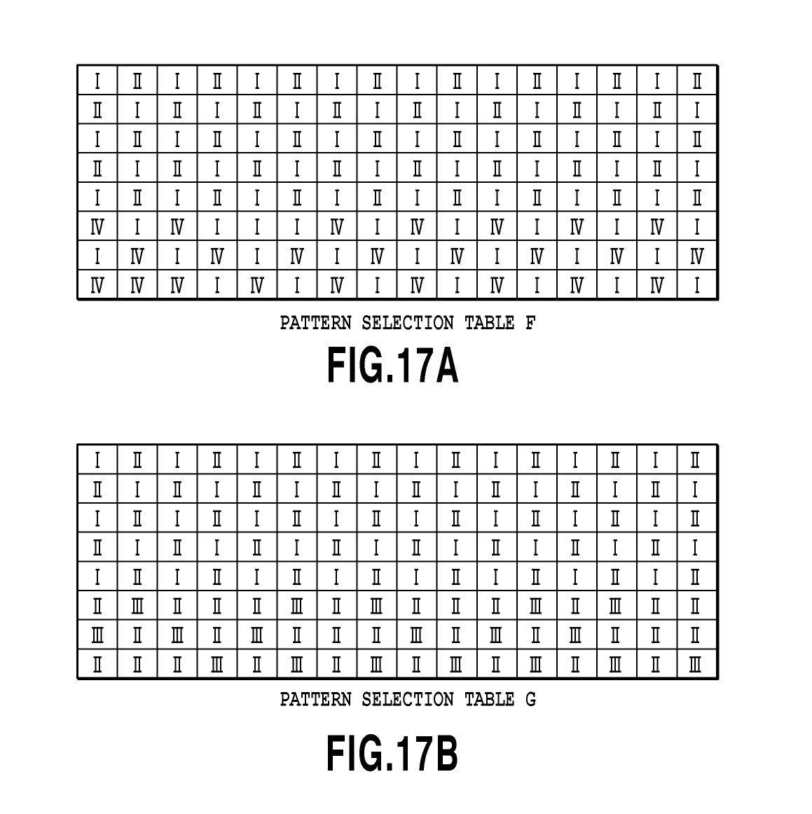

FIGS. 17A and 17B are diagrams showing pattern selection tables F and G for adjusting the number of dots in the three pixel rows at the lower end of the unit region, which are used in the case where the joint streak appears at the position above the boundary part. In the pattern selection table F shown in FIG. 17A, in the three-pixel width at the lower end, the patterns I and IV are allocated and in the other region, the patterns I and II are allocated. In the case where the pattern selection table F is used together with the dot arrangement pattern shown in FIG. 5, in the three-pixel width at the lower end, printing is performed with more dots increased by addition than those at the center.

On the other hand, in the pattern selection table G shown in FIG. 17B, in the three-pixel width at the lower end, the patterns II and III are allocated and in the other region, the patterns I and II are allocated. In the case where the pattern selection table G such as this is used together with the dot arrangement pattern shown in FIG. 5, in the three-pixel width at the lower end, printing is performed with less dots decreased by reduction than those at the center.

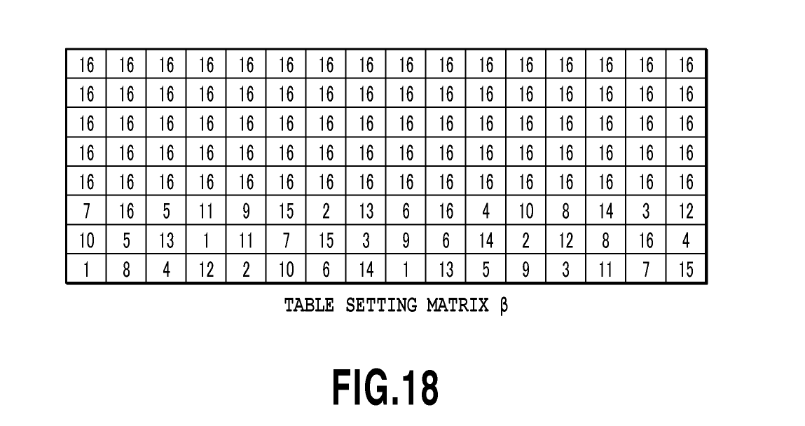

FIG. 18 is a diagram showing a table setting matrix β that can be used together with the above-described pattern selection tables F and G. In each pixel in the three pixel rows at the lower end, parameters 1 to 16 is allocated and in the other five-pixel width region, 16 is allocated uniformly.

As described above, by using both the pattern selection tables F and G shown in FIGS. 17A and 17B and the table setting matrix β shown in FIG. 18, the number of dots is adjusted only in the three-pixel width at the lower end of the unit region. As a result of that, it is possible to reduce the joint streak in a region narrower than that in the first or second embodiment.

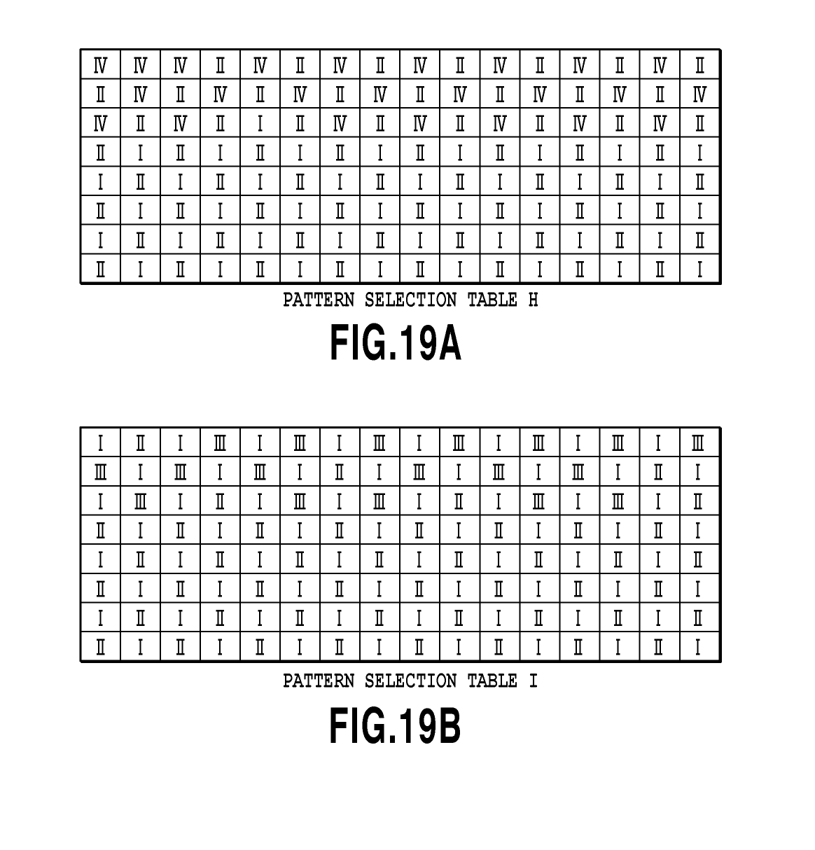

On the other hand, FIGS. 19A and 19B are diagrams showing pattern selection tables H and I for adjusting the number of dots in the three pixel rows at the upper end of the unit region, which are used in the case where the joint streak appears at the position below the boundary part. In the pattern selection table H shown in FIG. 19A, in the three-pixel width at the upper end, the patterns I, II, and IV are allocated and in the other region, the patterns I and II are allocated. In the case where the pattern selection table H such as this is used together with the dot arrangement pattern shown in FIG. 5, in the three pixel rows at the upper end, printing is performed (under eject control) with more dots increased by addition than those at the center.

On the other hand, in the pattern selection table I shown in FIG. 19B, in the three pixel rows at the upper end, the patterns I, II, and III are allocated and in the other region, the patterns I and II are allocated. In the case where the pattern selection table I is used together with the dot arrangement pattern shown in FIG. 5, in the three pixel rows at the upper end, printing is performed with less dots decreased by reduction than those at the center.

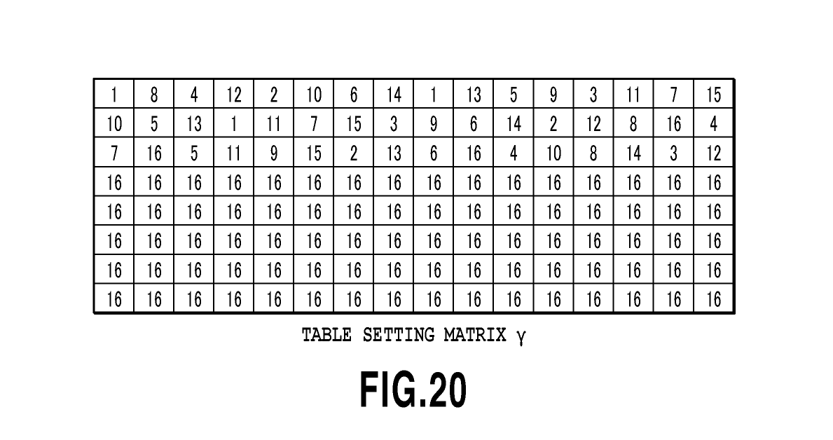

FIG. 20 is a diagram showing a table setting matrix γ that can be used together with the above-described pattern selection tables H and I. In each pixel in the three pixel rows at the upper end, one of parameters 1 to 16 is allocated and in the other five-pixel width region, 16 is allocated uniformly.

As described above, by using both the pattern selection tables H and I shown in FIGS. 19A and 19B and the table setting matrix γ shown in FIG. 20, the number of dots is adjusted only in the three-pixel width at the upper end of the unit region. As a result of that, it is possible to reduce the joint streak in a region narrower than that in the first or second embodiment.

At this time, by referring to FIG. 18 and FIG. 20, it is known that in the table setting matrixes β and γ in the present embodiment, parameters in each pixel row are set such that the number of parameters smaller than the increase/decrease parameter P decreases in the order from the first pixel row at the upper end part or at the lower end part. Consequently, the number of pixels in which the pattern III or IV is set is the largest in the pixel row at the lowermost end or the uppermost end adjacent to the boundary part and the number of such pixels decreases as the pixel row becomes more distant from the boundary part. As a result, it is possible to perform correction so that the ratio of the increase/decrease of dots is higher in the pixel row closer to the boundary part where the intensity of the joint streak is high and the ratio of the increase/decrease of dots is decreased as the pixel row becomes more distant from the boundary.

In the embodiment explained above, the table setting matrix is such that the ratio in which the two pattern selection tables are set linearly changes for each pixel row in the three pixel rows, which is the target region of correction. Specifically, as is known by referring to FIG. 8 again, the number of pixels in which the parameter is set to 1 linearly decreases in such a manner as that the number of such pixels is two in the pixel row at the uppermost or lowermost end, one in the second pixel row, and zero in the third pixel row. Further, it is also known that the number of pixels in which the parameter is set to 16 linearly increases in such a manner as that the number of such pixels is zero in the pixel row at the uppermost or lower most end, one in the second pixel row, and two in the third pixel row. Then, due to the linear change in the number of each parameter such as this, the number of pixels in which the dot arrangement pattern that causes the addition of dots or the dot arrangement pattern that causes the reduction of dots is set also changes linearly. However, the present invention is not limited to the aspect such as this. It is only required to adjust the number of dots to an appropriate number in each pixel row included in the region of the joint streak in order to make the joint streak that appears with a certain spread no longer conspicuous.

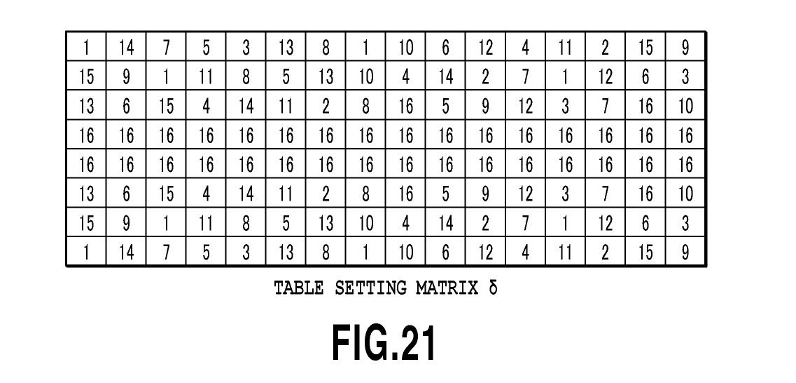

FIG. 21 is a diagram showing another example of the table setting matrix (table setting matrix δ) that can be used in the first embodiment or the second embodiment. As in the table setting matrix α, parameters “1” to “16” are allocated in the three pixel rows at the upper and lower ends and in the two pixel rows at the center, “16” is allocated uniformly. However, in the table setting matrix δ, in the first pixel row and in the second pixel row from the uppermost or lowermost end, the number of pixels in which the same parameter is allocated is the same. Specifically, both in the first pixel row and in the second pixel row from the uppermost or lowermost end, there exist two pixels in which the parameter is set to 1 and in each of the other pixels, the parameter is set to one and the different one of 2 to 15, and there exists no pixel in which the parameter is set to 16. Then, in the third pixel rows from the uppermost end and the lowermost end, there exist no pixel in which the parameter is set to 1 and in each of 14 pixels, the parameter is set to one and the different one of 2 to 15, and there exist two pixels in which the parameter is set to 16. Even in the case where the table setting matrix δ is used, the number of pixels in which a parameter smaller than the density increase/decrease parameter P is set gradually decreases as the pixel row becomes more distant from the uppermost or lowermost end, i.e., the boundary part. In other words, it is made possible to adjust stepwise the ratio in which the pattern selection table A and the pattern selection B are set, respectively, for each pixel row.

In the above, explanation is given by using the configuration in which the number of dots is adjusted in the region of the three pixel rows from the boundary part. However, the range in which the joint streak appears (width of the joint streak) varies depending on the kind of ink or the kind of printing medium. Consequently, it is preferable to adjust the range in which the number of dots also in accordance with the range in which the joint streak appears.

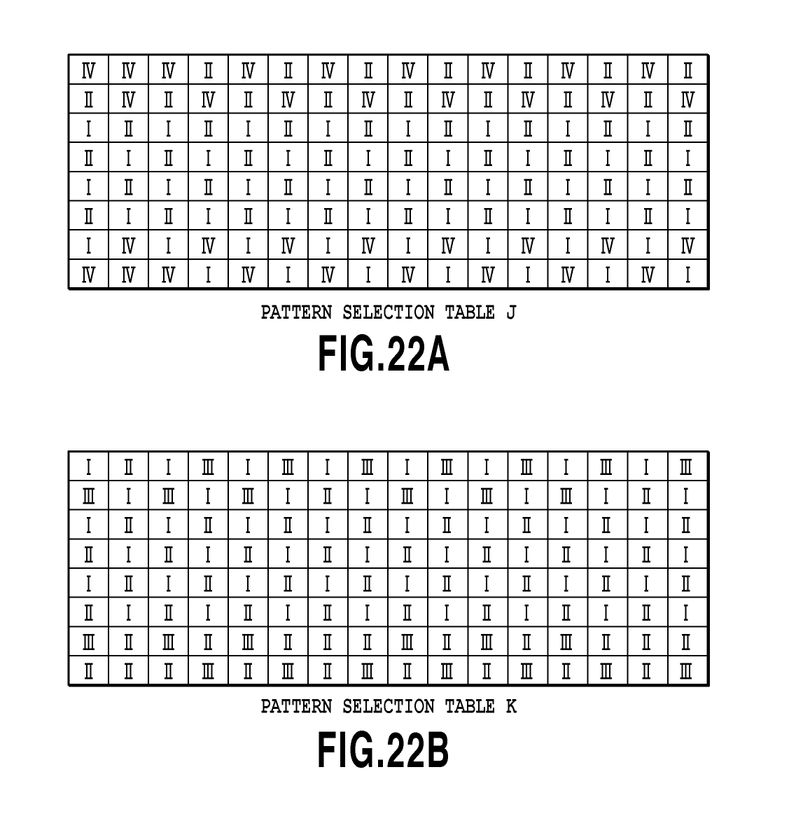

FIGS. 22A and 22B are diagrams showing pattern selection tables J and K that can be used in the case where the range in which the number of dots is adjusted is set to the region of the two pixel rows from the boundary part. In the pattern selection table J shown in FIG. 22A, in the two pixel rows at the upper end and the lower end, the patterns I, II, and IV are allocated and in the four-pixel width at the center except for the upper end and the lower end, the patterns I and II are allocated. In the pattern selection table K shown in FIG. 22B, in the two pixel rows at the upper end and the lower end, the patterns I, II, and III are allocated and in the four-pixel width at the center except for the upper end and the lower end, the patterns I and II are allocated.

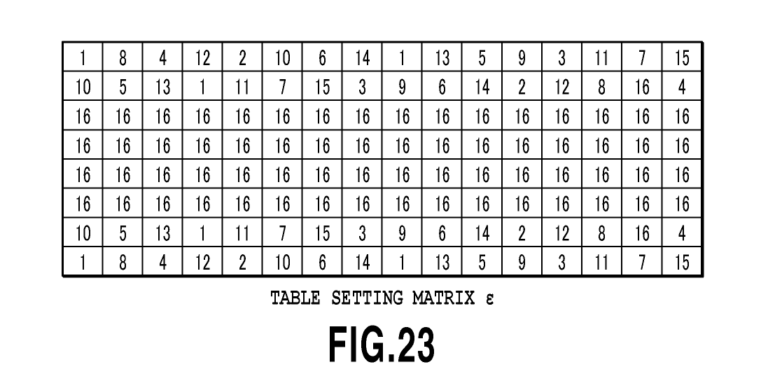

FIG. 23 is a diagram showing a table setting matrix ε that can be used together with the above-described pattern selection tables J and K. In each pixel in the two pixel rows at the upper end and in the two pixel rows at the lower end, one of parameters “1” to “16” is allocated and in the four-pixel width region at the center, “16” is allocated uniformly. In the table setting matrix ε, in the pixel rows at the uppermost end and the lowermost end, there exist two pixels in which the parameter is set to “1” and in each of the other pixels, the parameter is set to one and the different one of “2” to “15”, and there exists no pixel in which the parameter is set to “16”. Then, in the second pixel rows from the uppermost end and the lowermost end, in each pixel, the parameter is set to one and the different one of parameters “1” to “16”. Even in the case where the table setting matrix E such as this is used, the number of pixels in which a parameter smaller than the density increase/decrease parameter P is set decreases stepwise from the uppermost or lowermost end, i.e., the boundary part toward the center part. Therefore, it is possible to adjust the ratio stepwise in which the pattern selection table J and the pattern selection K are set, respectively, for each pixel row.

In the printing apparatus, it is possible to store a variety of combinations, such as the combination of the pattern selection table A and B and the table setting matrix α explained in the first embodiment and the combination of the pattern selection tables J and K and the table setting matrix ε. By doing so, it is possible to eliminate the joint streak by an appropriate combination in accordance with each situation even in the case where the state of the joint streak has changed resulting from a variety of conditions, such as the kind of printing medium, the kind of ink, and the printing mode.

Further, the parameter array of the correction row in the table setting matrix is not limited in particular as long as the parameter array has the characteristics that the number of pixels in which a parameter smaller than the density increase/decrease parameter P is set changes at least in two steps from the uppermost or lowermost end. In the region in which correction is performed, in the dot arrangement patterns (patterns I, II) whose number of dots is the default value, the dot arrangement patterns (patterns III, IV) whose number of dots is not the default value are arranged as a result. At this time, even in the case where the density can be made uniform in the entire region in which correction is performed, there is a possibility that the texture or the feeling of granularity will occur in the vicinity of the boundary part depending on the state where dot arrangement patterns whose number of dots is different from the default value are arranged. Consequently, it is preferable to arrange dot arrangement patterns whose number of dots is different from the default value in a relatively highly dispersed state. In this case, it is effective to arrange the individual parameters in the Bayer arrangement or so as to have the blue noise characteristics in the table setting matrix.

In the above-described embodiment, the number of pixels in the Y direction in the pattern selection table and in the table setting matrix is set to the number of pixels equal to the width of the eject port column used in printing, but the size of the pattern selection table and the table setting matrix is not limited to this. However, in the case where a plurality of pattern selection tables is arranged as in FIG. 6, the number of pixels in the Y direction of the pattern selection table and the table setting matrix needs to be an integer multiple of the unit region width, i.e., the eject port column width in order to match the correction width with the position of the joint streak.

Furthermore, in the above, explanation is given by premising that the one-pass printing is performed, but the configuration of the present invention can also be adopted even in the case where multi-pass printing is performed. Even in the case of multi-pass printing, the position where the joint streak appears is fixed, and therefore, by preparing pattern selection tables and a table setting matrix whose correction width is matched with such a position and by adjusting the correction width in accordance with the printing conditions, it is possible to obtain the same effect as that in the above-described embodiment.

Furthermore in the above, the parameter dispersed state in the table setting matrix is caused to have the characteristics so as to decrease the ratio of the addition or reduction of dots for correction as the pixel row becomes more distant from the boundary part, but the present invention is not limited to the aspect such as this. For example, it is also possible to perform correction by using a mask pattern by which the ratio of the addition or reduction of dots gradually changes from the boundary part toward the center part by counting the number of pieces of dot data after binarization in the vicinity of the boundary part and setting the counted value as the density increase/decrease parameter P. In either aspect, in the case where the degree of the increase/decrease of dots to and from the original image data decreases as the distance from the boundary part increases at the time of performing the addition or reduction of dots in the vicinity of the boundary part of the input image data, it is possible to obtain the same effect of the prevent invention.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment (s) and/or that includes one or more (ASIC)) for performing the functions of one or more of the above-described embodiment (s), and by a method performed by the computer of the system or apparatus by, for example, reading out and executing the computer executable instructions from the storage medium to perform the functions of one or more of the above-described embodiment (s) and/or controlling the one or more circuits to perform the functions of one or more of the above-described embodiment (s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-265378 filed Dec. 24, 2013, which is hereby incorporated by reference wherein in its entirety.

What is claimed is:

1. An ink jet printing apparatus that prints an image on a printing medium by repeating a printing scan wherein an eject port column, in which eject ports for ejecting ink to print dots on the printing medium in accordance with image data are arrayed, is moved with respect to the printing medium and a conveyance operation to convey the printing medium in a direction intersecting the direction of the printing scan, the ink jet printing apparatus comprising:
a conveyance control unit configured to control the printing scan and the conveyance operation so that a position where dots are printed by the eject port located at one end part of the eject port column and a position where dots are printed by the eject port located at the other end part are adjacent to each other via a boundary part by the printing scan performed twice on the printing medium; and
a correction unit configured to perform correction processing on image data corresponding to the vicinity of the boundary part in order to adjust the number of dots that are printed,
wherein the correction unit performs the correction processing so that a ratio in which the number of dots that are printed is increased or decreased from a default value based on the image data is changed at least in two steps toward a direction in which the distance from the boundary part increases.

2. The ink jet printing apparatus according to claim 1, wherein
the correction unit performs the correction processing so that a ratio in which the number of dots that are printed is increased from the default value is decreased at least in two steps toward a direction in which the distance from the boundary part increases.

3. The ink jet printing apparatus according to claim 1, wherein
the correction unit performs the correction processing so that a ratio in which the number of dots that are printed is decreased from the default value is decreased at least in two steps toward a direction in which the distance from the boundary part increases.

4. The ink jet printing apparatus according to claim 1, wherein
the correction unit performs the correction processing so that a ratio in which the number of dots that are printed is increased or decreased from the default value is changed at least in two steps toward a direction in which the distance from the boundary part increases on both sides of the boundary part.

5. The ink jet printing apparatus according to claim 1, further comprising:
a unit configured to store a plurality of dot arrangement patterns in which the position and number of dots that are printed in a region corresponding to a pixel of a printing medium are determined in association with a level value indicated by image data of the pixel, including a dot arrangement pattern whose number of dots that are printed in the region is the default value for a predetermined level value and a dot arrangement pattern whose number of dots that are printed in the region is increased or decreased from the default value,
wherein the correction unit sets the dot arrangement pattern for each pixel so that a ratio of pixels in which the dot arrangement pattern whose number of dots that are printed is increased or decreased from the default value is set is changed at least in two steps toward a direction in which the distance from the boundary part increases.

6. The ink jet printing apparatus according to claim 1, wherein
the correction unit makes a ratio in which the number of dots that are printed is increased or decreases from a default value based on the image data different in accordance with the kind of ink.

7. The ink jet printing apparatus according to claim 1, wherein
the correction unit makes a ratio in which the number of dots that are printed is increased or decreases from a default value in accordance with the image data different in accordance with the kind of the printing medium.

8. An image processing apparatus that performs processing on multivalued image data corresponding to a unit region for printing an image in the unit region including a plurality of pixel regions on a printing medium by a plurality of scans of a an eject port column in which a plurality of eject ports for ejecting ink are arrayed in a predetermined direction with respect to the printing medium, wherein the plurality of eject ports ejects ink to each of the plurality of pixel regions on the printing medium in accordance with dot printing data corresponding to each of the plurality of scans, and by conveying the printing medium between the plurality of scans, the image processing apparatus comprising:
a first acquisition unit configured to acquire information on a density of an image that is printed in the pixel region;
a second acquisition unit configured to acquire N (≧3)-valued quantized data corresponding to the pixel region based on the image data;
a third acquisition unit configured to acquire a plurality of dot arrangement pattern groups including at least a first dot arrangement pattern group including a plurality of first dot arrangement patterns in which an arrangement of dots is determined so that the number and position of dots that are printed within the pixel region are different in accordance with a value of the N-valued quantized data and a second dot arrangement pattern group including a plurality of second dot arrangement patterns in which an arrangement of dots is determined so that the number and position of dots that are printed within the pixel region are different in accordance with a value of the N-valued quantized data;
a setting unit configured to set one dot arrangement pattern group from the plurality of dot arrangement pattern groups acquired by the third acquisition unit in accordance with the positions of the plurality of pixel regions within the unit region; and
a generation unit configured to generate the dot printing data based on the N-valued quantized data acquired by the second acquisition unit and the dot arrangement pattern group set by the setting unit,
wherein the number of dots that are printed within the pixel region determined by the second dot arrangement pattern corresponding to the N-valued quantized data having a predetermined value is smaller than the number of dots that are printed within the pixel region determined by the first dot arrangement pattern corresponding to the N-valued quantized data having the predetermined value, and
the setting unit sets the dot arrangement pattern group so that:
(i) the number of the second dot arrangement pattern groups determined for the plurality of pixel regions located at a first position, that is included in an end part region of the unit region in the predetermined direction corresponding to an end part of the eject port column in the predetermined direction, in a case where the density of the image indicated by the information acquired by the first acquisition unit is a first value is smaller than the number of the second dot arrangement pattern groups determined for the plurality of pixel regions located at the first position in a case where the density of the image indicated by the information acquired by the first acquisition unit is a second value lower than the first value;
(ii) the number of the second dot arrangement pattern groups determined for the plurality of pixel regions located at a second position, that is included in the end part region and is closer to an end of the unit region than the first position in the predetermined direction, in a case where the density of the image indicated by the information acquired by the first acquisition unit is the first value is smaller than the number of the second dot arrangement pattern groups determined for the plurality of pixel regions located at the second position in a case where the density of the image indicated by the information acquired by the first acquisition unit is the second value; and
(iii) the number of the second dot arrangement pattern groups determined for the plurality of pixel regions located at the second position in a case where the density of the image indicated by the information acquired by the first acquisition unit is the second value is larger than the number of the second dot arrangement pattern groups determined for the plurality of pixel regions located at the first position in a case where the density of the image indicated by the information acquired by the first acquisition unit is the second value, and
the number of the first dot arrangement pattern groups determined for the plurality of pixel regions located at the second position in a case where the density of the image indicated by the information acquired by the first acquisition unit is the second value is smaller than the number of the first dot arrangement pattern groups determined for the plurality of pixel regions located at the first position in a case where the density of the image indicated by the information acquired by the first acquisition unit is the second value.

9. The image processing apparatus according to claim 8, further comprising:
a third dot arrangement pattern group including a plurality of third dot arrangement patterns in which an arrangement of dots is determined so that the number and position of dots that are printed within the pixel region are different in accordance with a value of the N-valued quantized data,
wherein the number of dots that are printed within the pixel region determined by the third dot arrangement pattern corresponding to the N-valued quantized data having the predetermined value is larger than the number of dots that are printed within the pixel region determined by the first dot arrangement pattern corresponding to the N-valued quantized data having the predetermined value, and
the setting unit sets the dot arrangement pattern group so that:
(i) the number of the third dot arrangement pattern groups determined for the plurality of pixel regions located at the first position in a case where the density of the image indicated by the information acquired by the first acquisition unit is a first value is smaller than the number of the third dot arrangement pattern groups determined for the plurality of pixel regions located at the first position in a case where the density of the image indicated by the information acquired by the first acquisition unit is a third value higher than the first value;
(ii) the number of the third dot arrangement pattern groups determined for the plurality of pixel regions located at the second position in a case where the density of the image indicated by the information acquired by the first acquisition unit is the first value is smaller than the number of the third dot arrangement pattern groups determined for the plurality of pixel regions located at the second position in a case where the density of the image indicated by the information acquired by the first acquisition unit is the third value; and
(iii) the number of the third dot arrangement pattern groups determined for the plurality of pixel regions located at the second position in a case where the density of the image indicated by the information acquired by the first acquisition unit is the third value is larger than the number of the third dot arrangement pattern groups determined for the plurality of pixel regions located at the first position in a case where the density of the image indicated by the information acquired by the first acquisition unit is the third value.

10. The image processing apparatus according to claim 9, wherein
the setting unit sets the dot arrangement pattern group by using a first table in which the first dot arrangement pattern group or the second dot arrangement pattern group is set for each of the plurality of pixel regions within the unit region and a second table in which the first dot arrangement pattern group or the third dot arrangement pattern group is set for each of the plurality of pixel regions within the unit region.

11. The image processing apparatus according to claim 10, wherein
in the first table, the first dot arrangement pattern or the second dot arrangement pattern is set so that the number of the second dot arrangement pattern groups arranged at the second position is larger than the number of the second dot arrangement pattern groups arranged at the first position.

12. The image processing apparatus according to claim 11, wherein
in the second table, the first dot arrangement pattern or the third dot arrangement pattern is set so that the number of the third dot arrangement pattern groups arranged at the second position is larger than the number of the third dot arrangement pattern groups arranged at the first position.

13. The image processing apparatus according to claim 10, wherein
the setting unit further uses a threshold value matrix in which a different threshold value is determined for each of the plurality of pixel regions within the unit region and selects the first table in a case where the density of the image indicated by the information acquired by the first acquisition unit is lower than a threshold value determined by the threshold value matrix and selects the second table in a case where the density of the image indicated by the information acquired by the first acquisition unit is equal to or higher than a threshold value determined by the threshold value matrix.

14. An image processing apparatus that performs processing on multivalued image data corresponding to a unit region for printing an image in the unit region including a plurality of pixel regions on a printing medium by a plurality of scans of a an eject port column in which a plurality of eject ports for ejecting ink are arrayed in a predetermined direction with respect to the printing medium, wherein the plurality of eject ports ejects ink to each of the plurality of pixel regions on the printing medium in accordance with dot printing data corresponding to each of the plurality of scans, and by conveying the printing medium between the plurality of scans, the image processing apparatus comprising:
a first acquisition unit configured to acquire information on a density of an image that is be printed in the pixel region;
a second acquisition unit configured to acquire N (≧3)-valued quantized data corresponding to the pixel region based on the image data;
a third acquisition unit configured to acquire a plurality of dot arrangement pattern groups including at least a first dot arrangement pattern group including a plurality of first dot arrangement patterns in which an arrangement of dots is determined so that the number and position of dots that are printed within the pixel region are different in accordance with a value of the N-valued quantized data and a second dot arrangement pattern group including a plurality of second dot arrangement patterns in which an arrangement of dots is determined so that the number and position of dots that are printed within the pixel region are different in accordance with a value of the N-valued quantized data;
a setting unit configured to set one dot arrangement pattern group from the plurality of dot arrangement pattern groups acquired by the third acquisition unit in accordance with the positions of the plurality of pixel regions within the unit region; and
a generation unit configured to generate the dot printing data based on the N-valued quantized data acquired by the second acquisition unit and the dot arrangement pattern group set by the setting unit,
wherein the number of dots that are printed within the pixel region determined by the second dot arrangement pattern corresponding to the N-valued quantized data having a predetermined value of the first and second dot arrangement pattern groups is larger than the number of dots that are printed within the pixel region determined by the first dot arrangement pattern corresponding to the N-valued quantized data having the predetermined value, and
the setting unit sets the dot arrangement pattern group so that:
(i) the number of the second dot arrangement pattern groups determined for the plurality of pixel regions located at a first position, that is included in an end part region of the unit region in the predetermined direction corresponding to an end part of the eject port column in the predetermined direction, in a case where the density of the image indicated by the information acquired by the first acquisition unit is a first value is smaller than the number of the second dot arrangement pattern groups determined for the plurality of pixel regions located at the first position in a case where the density of the image indicated by the information acquired by the first acquisition unit is a second value higher than the first value;
(ii) the number of the second dot arrangement pattern groups determined for the plurality of pixel regions located at a second position, that is included in the end part region and is closer to an end of the unit region than the first position in the predetermined direction, in a case where the density of the image indicated by the information acquired by the first acquisition unit is the first value is smaller than the number of the second dot arrangement pattern groups determined for the plurality of pixel regions located at the second position in a case where the density of the image indicated by the information acquired by the first acquisition unit is the second value; and
(iii) the number of the second dot arrangement pattern groups determined for the plurality of pixel regions located at the second position in a case where the density of the image indicated by the information acquired by the first acquisition unit is the second value is larger than the number of the second dot arrangement pattern groups determined for the plurality of pixel regions located at the first position in a case where the density of the image indicated by the information acquired by the first acquisition unit is the second value, and
the number of the first dot arrangement pattern groups determined for the plurality of pixel regions located at the second position in a case where the density of the image indicated by the information acquired by the first acquisition unit is the second value is smaller than the number of the first dot arrangement pattern groups determined for the plurality of pixel regions located at the first position in a case where the density of the image indicated by the information acquired by the first acquisition unit is the second value.

15. An image processing apparatus that performs processing on multivalued image data corresponding to a unit region for printing an image in the unit region including a plurality of pixel regions on a printing medium by a plurality of scans of a an eject port column in which a plurality of eject ports for ejecting ink are arrayed in a predetermined direction with respect to the printing medium, wherein the plurality of eject ports ejects ink to each of the plurality of pixel regions on the printing medium in accordance with dot printing data corresponding to each of the plurality of scans, and by conveying the printing medium between the plurality of scans, the image processing apparatus comprising:
a first acquisition unit configured to acquire information on a density of an image that is be printed in the pixel region;
a second acquisition unit configured to acquire N (≧3)-valued quantized data corresponding to the pixel region based on the image data;
a third acquisition unit configured to acquire a plurality of dot arrangement pattern groups including at least a first dot arrangement pattern group including a plurality of first dot arrangement patterns in which an arrangement of dots is determined so that the number and position of dots that are printed within the pixel region are different in accordance with a value of the N-valued quantized data and a second dot arrangement pattern group including a plurality of second dot arrangement patterns in which an arrangement of dots is determined so that the number and position of dots that are printed within the pixel region are different in accordance with a value of the N-valued quantized data;
a setting unit configured to set one dot arrangement pattern group from the plurality of dot arrangement pattern groups acquired by the third acquisition unit in accordance with the positions of the plurality of pixel regions within the unit region; and
a generation unit configured to generate the dot printing data based on the N-valued quantized data acquired by the second acquisition unit and the dot arrangement pattern group set by the setting unit,
wherein the dot arrangement pattern group is set so that the number of the second dot arrangement pattern groups determined for the plurality of pixel regions located at a first position, that is included an end part region of the unit region in the predetermined direction corresponding to an end part of the eject port column in the predetermined direction, in a case where the density of the image indicated by the information acquired by the first acquisition unit is a predetermined value is smaller than the number of the second dot arrangement pattern groups determined for the plurality of pixel regions located at a second position, that is included in the end part region and is closer to an end of the unit region than the first position in the predetermined direction, in a case where the density of the image indicated by the information acquired by the first acquisition unit is the predetermined value, and
the number of the first dot arrangement pattern groups determined for the plurality of pixel regions located at the first position in a case where the density of the image indicated by the information acquired by the first acquisition unit is the predetermined value is larger than the number of the first dot arrangement pattern groups determined for the plurality of pixel regions located at the second position in a case where the density of the image indicated by the information acquired by the first acquisition unit is the predetermined value.
